(19) United States
(12) Patent Application Publication
(10) Pub. No.: US 2013/0007849 A1
(43) Pub. Date: Jan. 3, 2013

(54) SECURE CONSUMER AUTHORIZATION AND AUTOMATED CONSUMER SERVICES USING AN INTERMEDIARY SERVICE

(75) Inventors: Todd R. Coulter, Rancho Murieta, CA (US); Jeffery A. Warmington, Wellington, FL (US); Mordechai E. Kaplinsky, Brooklyn, NY (US)

(73) Assignee: FonWallet Transaction Soulutions, Inc., Rancho Murieta, CA (US)

(21) Appl. No.: 13/482,973

(22) Filed: May 29, 2012

Related U.S. Application Data
(60) Provisional application No. 61/490,504, filed on May 26, 2011.

(51) Int. Cl. G06F 21/00

(52) U.S. Cl. 726/4

(57) ABSTRACT

A transaction processing service that operates as an intermediary between aggregators of transaction requests, service providers, consumers, and third-party recipients of data, is disclosed. As used herein, a transaction request is a request for consumer services to be provided to a consumer or third-party, a consumer's authorization of such consumer services, and/or a consumer's authorization of applicable terms, policies, contracts, or agreements. The intermediary service utilizes a consumer's mobile device as an out-of-band communication channel to notify a consumer of a received transaction request and to receive a consumer's authorization of the transaction. Once a transaction is authorized, the intermediary service facilitates the consumer services related to the transaction and provides a service response from one or more service providers to the user's mobile device and/or another service target.

### CROSS-REFERENCE TO RELATED APPLICATION(S)

This application claims the benefit of U.S. Provisional Application No. 61/490,504 entitled “SECURE CONSUMER AUTHORIZATION AND AUTOMATED CONSUMER SERVICES USING AN INTERMEDIARY SERVICE” filed May 26, 2011, and incorporated herein by reference in its entirety.

### BACKGROUND

Often, it is desirable for an advertiser, merchant, service provider or others to transfer electronic data to a consumer or to a third-party. For example, it may be desirable for merchants to deliver electronic advertising content to a consumer who has expressed an interest in receiving product information at a “smart poster.” As another example, when a consumer visits his doctor's office for a referral to a third-party specialist, it may be desirable to transfer an electronic copy of the consumer's medical records to the specialist at the conclusion of the visit. It may also be desirable or necessary to obtain a consumer's consent or authorization prior to transferring data. For example, a merchant may wish to verify that their advertising content is not an unwanted intrusion on the consumer's privacy. Also, often it is desirable for an advertiser, merchant, service provider or others to obtain a consumer's acknowledgement, acceptance or authorization of terms, policies, or contracts that are applicable to a business deal or arrangement. For example, when a consumer rents a car, he may need to acknowledge and accept a standard rental contract, including terms such as a liability waiver.

Various short-range wireless communication technologies have been employed in the marketplace to identify the user's mobile device and to facilitate data transfer and consumer authorization. For example, Radio Frequency Identification Devices (“RFID”) and Near-Field Communication (“NFC”) devices have been employed in the marketplace for “smart” posters and payment transactions, among other applications. However, the current methods of utilizing these short-range communication technologies may have shortcomings for data transfers and consumer authorization.

FIG. 1 is an example of how a consumer may interact with a “smart poster” in order to initiate a data transfer to the consumer. As shown, a data transfer is initiated when a consumer 102 establishes a personal area network (“PAN”) session between the consumer's mobile device 106 and a smart poster 108 using a short-range communication protocol. For example, as shown in FIG. 1, a consumer 102 may initiate an NFC or Bluetooth session with a smart movie poster 108 in order to receive a trailer for the movie illustrated in the poster. After the PAN session is initiated, the poster 108 transfers data to the consumer's mobile device 106 via the short-range communication protocol. For example, the poster 108 may transmit a video file of the movie trailer directly to the mobile device 106 using an NFC protocol.

During the data transfer from the smart poster, the mobile device 106 may be registered with or otherwise connected to one or more wide area networks (WANs) (or another network substantially larger than a PAN, such as a metropolitan area network) using one or more long-range wireless protocols such as Global System for Mobile Communications (“GSM”), Time Division Multiple Access (“TDMA”), Universal Mobile Telecommunications System (“UMTS”), Evolution-Data Optimized (“EVDO”), Long Term Evolution (“LTE”), Generic Access Network (“GAN”), Unlicensed Mobile Access (“UMA”), Code Division Multiple Access (“CDMA”) protocols (including IS-95, IS-2000, and IS-856 protocols), Advanced LTE or LTE+, Orthogonal Frequency Division Multiple Access (“OFDM”), General Packet Radio Service (“GPRS”), Enhanced Data GSM Environment (“EDGE”), Advanced Mobile Phone System (“AMPS”), WiMAX protocols (including IEEE 802.16e-2005 and IEEE 802.16m protocols), Wireless Fidelity (“WiFi”), High Speed Packet Access (“HSPA”) (including High Speed Downlink Packet Access (“HSDPA”) and High Speed Uplink Packet Access (“HSUPA”)), Ultra Mobile Broadband (“UMB”), SUPL, IP Multimedia Subsystem (“IMS”), IEEE 802.11 (“WiFi”), revisions of these protocols, and/or protocols associated with similar networks serving the same or similar functions, and/or the like. For example, during the data transfer, the mobile device 106 may be registered with a wireless telecommunication and data network 114 and communicating with the network using a UMTS protocol. However, typically the data transfer between the mobile device 106 and the smart poster 108 is not initiated by the network over the WAN but instead the entirety of the data transfer occurs over a PAN using a short-range communication protocol supported by the hardware and software of the mobile device 106 (e.g., via NFC, Bluetooth, Z-Wave, ZigBee, etc.).

In order to receive data from the smart poster 108, the mobile device 106 needs a specialized active communication component capable of performing the short-range communication protocol, such as a Bluetooth or NFC component. Thus, typically the smart poster 108 can only effectively reach those consumers who have invested in a mobile device comprising the specialized short-range communication component. Phrased another way, the consumer 102 shoulders much of the hardware cost of the data transfer, despite the fact that the data transfer primarily benefits the operator of the smart poster 108 (e.g., an advertiser).

Additionally, depending on the configuration of the mobile device 106, the configuration of the smart poster 108, and the short-range protocol used, the consumer 102 may need to take one or more proactive steps in order to initiate data transfer using a short-range communication protocol. For example, to establish a Bluetooth connection, the consumer 102 may need to utilize a system settings menu to turn on an internal Bluetooth communication component, adjust the configuration of the Bluetooth component so that it is “discoverable,” and/or initiate or accept a pairing request with the smart poster 108; alternatively, the mobile device may need to maintain an active application, which can quickly drain the device's battery.

Furthermore, in the prior art method depicted in FIG. 1, the consumer 102 must inherently trust the operator of the smart poster 108. For example, since the consumer is agreeing to receive data from the smart poster, the consumer must trust the operator of the smart poster 108 to provide only the promised information and not to install viruses, malware, spyware, etc. As another example, the consumer must trust that the operator of the smart poster 108 will not try to access or retrieve personal information from the consumer's mobile device 106 during the PAN session.

Finally, in the depicted prior art method, the operator of the smart poster 108 may have limited ability to verify the identity of the consumer 102 or to perform an analytical analysis of consumer behavior. For example, although the smart poster 108 potentially receives some limited information from the consumer (e.g., a hardware identifier associated with an NFC component), the operator likely has no ability to correlate that identifier to an individual person or to demographic information without active participation of additional parties.

### BRIEF DESCRIPTION OF THE DRAWINGS

FIG. 1 illustrates a prior art method of transferring data to a consumer using short-range communication protocols.

FIG. 2A is a block diagram that illustrates communication steps for initially processing a transaction request using an intermediary service.

FIG. 2B is a block diagram that illustrates communication steps for requesting consumer services and providing a service response to a consumer or another service target.

FIG. 2C is a block diagram that illustrates communication steps for providing an authorizing report and a notification message.

FIGS. 3A-3E are representative user interfaces presented to a consumer of a mobile device when processing a transaction request.

FIG. 4 is a block diagram of a representative server architecture.

FIG. 5 is a logical block diagram of the intermediary service.

FIGS. 6A and 6B are a flow chart of a process for processing transaction requests executed by an intermediary service.

FIG. 6C is a flow chart of a process for defining rules to be executed by the intermediary service.

FIG. 6D is a flow chart of a process for processing rules by the intermediary service.

FIG. 6E is a flow chart of a process for providing intermediary services to a consumer.

FIG. 7 is a flowchart of a process for processing a transaction request executed by a request aggregator.

FIG. 8 is a logical block diagram of the request aggregator.

FIG. 9 is a block diagram of encrypted message routing through the intermediary service.

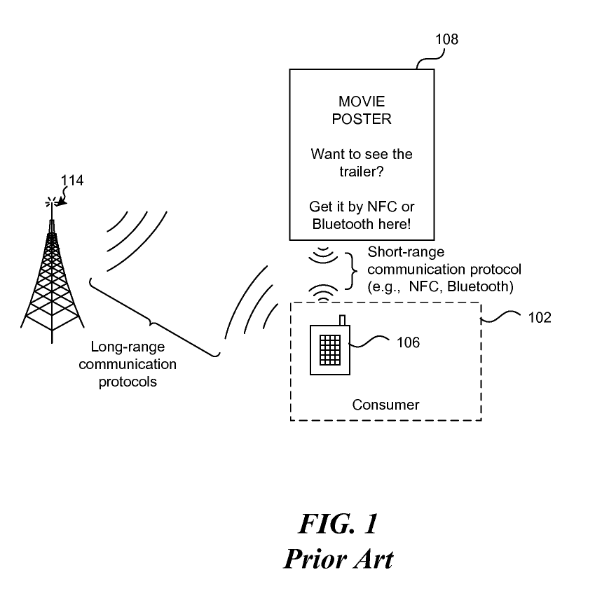

### DETAILED DESCRIPTION

A transaction processing service that operates as an intermediary between aggregators of transaction requests, service providers, consumers, and third-party recipients of consumer services, is disclosed (hereinafter referred to as “the intermediary service”). As used herein, a “transaction” is the provisioning of one or more consumer services in response to a single implicit or explicit request for consumer services from a consumer. Non-exhaustive examples of consumer services that may be provided in conjunction with a transaction include financial services, ticketing services, loyalty programs, document or data control services, access control service, membership control services, identity verification services, and data transfer services.

A single transaction may involve the provisioning of any number or combination of consumer services. Additionally, a requested consumer service may inure to the benefit of the requesting consumer and/or a third-party. As an example, a single transaction may occur as a consumer enters an adult-only music venue. Such a transaction may involve (1) a ticketing service that provides a seat assignment in the venue to the consumer and (2) an age verification service, e.g., which notifies the venue that the consumer is over the age of majority. As another example, when a consumer checks into a medical facility, the transaction may involve identifying a user and requesting authorization to transfer medical records from different data sources (e.g., a primary care physician, specialist, and imaging center) and obtaining insurance coverage information from the consumer's insurer along with the credit card to pay all outstanding and/or uncovered balances. As yet another example, when a consumer purchases items at a store, the transaction may involve the retrieval and application of multiple coupons from different issuers plus an associated credit card payment service.

A transaction may also include a consumer's acknowledgment or acceptance (“authorization”) of the provisioning of consumer services (e.g., the authorization of a data transfer) and/or a consumer's authorization of terms, policies, contracts, agreements or similar obligations or limitations applicable to the transaction. A transaction may be related to an underlying business deal or arrangement, such as a purchase/sale deal between a merchant and a consumer. However, as used herein, a transaction does not include requests for services for payment or other monetary remuneration.

The intermediary service utilizes a consumer's mobile device as an out-of-band communication channel to solicit the consumer's authorization of the transaction and/or to notify the consumer regarding the consummation of a transaction. In certain circumstances, before continuing to process a received transaction request, the intermediary service must first receive the consumer's implicit or explicit authorization of the transaction or a portion of the transaction. By seeking out-of-band authorization from a consumer involved in a transaction, the disclosed intermediary service prevents the consummation of unwanted or fraudulent transactions. The out-of-band authorization may also provide additional verification of the consumer's identity and the consumer's acceptance of applicable transaction terms.

To initiate a transaction request, a consumer actively or passively presents an identifier that embodies unique identifying information to a point of request system located proximate to the consumer. The point of request system may be operated by a merchant or other transaction “requester.”

In one example, a consumer actively presents to a point of request system an identifier that embodies unique identifying information associated with the consumer. The identifier may be, for example, an RFID tag or other contactless device for providing the unique identifying information; the tag may be contained in or attached to the consumer's mobile device. Since simple RFID tags or similar devices are inexpensive, the intermediary service, a requester, a merchant, or another party may provide the identifier to the consumer for free or at low cost. For example, the intermediary service may provide, to the general public or to consumers who register with the intermediary service, after-market RFID tags that are readily attachable to a mobile device. In this way, the processes described herein may reach many consumers, even those who do not have mobile devices integrally equipped with specialized, active, short-range communication components such as an NFC or Bluetooth component. In other examples, the point of request system may automatically initiate a request in response to detecting the consumer identifier in a particular area. For example, a retail establishment may have a femtocell or other wireless system capable of detecting a consumer's mobile device in the establishment. The retail establishment may initiate a request (e.g., for advertising or coupon services) in response to detecting that the mobile device has entered the establishment.

The point of request system transmits the unique identifying information received from an identifier to a request aggregator in a transaction request. The point of request system may also indicate the types of consumer services requested and additional transaction details needed to provision the requested services. The request aggregator recognizes that the transaction request is associated with the intermediary service based on the unique identifying information, and transmits at least part of the original transaction request to the intermediary service. The intermediary service authenticates the request, further reviews and defines relevant services and applications, and retrieves stored consumer information and applicable transaction processing rules from a database based on the identifying information and other transaction information. The stored consumer information includes an address of the consumer's mobile device and may also include, for example, a verification code associated with the consumer's intermediary service account.

If required by applicable transaction processing rules, using the retrieved address of the device, the intermediary service transmits an authorization message to the consumer's mobile device. The authorization message may indicate the name or location of the requester; what consumer services will be provided, including details of the services, such as an indication of data that will be transferred as a result of the service; an intended recipient of consumer services, e.g., an intended recipient of data; applicable transaction terms, policies, contracts, or agreements; and/or other information related to the transaction. The authorization message may also specify a required authorization response from the consumer. The required response may vary depending on the requester, the consumer, the consumer services requested, the intended recipient or other details of the consumer services, such as the type of data being transferred, or another factor associated with the transaction. For example, a transaction that involves the transfer of advertising data to a consumer's mobile device from a “trusted” merchant may require no response, a transaction that involves the transfer of non-sensitive data to a third-party data recipient may require that the consumer confirm that the transaction is authorized via an authorization response, and a transaction that involves the transfer of sensitive data or the consumer's acceptance of an important contract may require that the consumer confirm the transaction in an authorization response and provide a verification code in response to the authorization message. The authorization message is presented to the consumer on the mobile device. However, the intermediary service may also support fallback methods for transmitting the authorization message to the consumer in the event that the primary method of sending the message to the consumer is not available.

If, under the applicable transaction processing rules, an authorization response is required from the consumer in order to proceed with a transaction, the consumer's response is received by the mobile device and transmitted to the intermediary service. The intermediary service continues processing of the transaction request based on the consumer's response. If the consumer fails to respond to the authorization message, rejects the transaction, or provides an incorrect verification code, the intermediary service does not proceed with some or all of the consumer services related to the transaction, sends an authorization report to the request aggregator indicating that the consumer has not given authorization, and/or takes other action based on applicable rules or other algorithms and metrics provided by the consumer, a service provider, the intermediary service, another party (e.g., an issuer).

If, under the applicable transaction processing rules, no consumer response is required, the consumer authorizes the transaction, or the consumer authorizes the transaction and provides a correct verification code, the intermediary service transmits one or more service requests to one or more service providers to provide the requested consumer services related to the transaction, including for example, requested data transfers. In response to receiving a service request, each service provider takes various steps to perform the service requested of it. In some examples, the service provider sends a service response, such as requested data, to the intermediary service. The intermediary service may forward a service response (e.g., requested data) to the consumer's mobile device or to another location, such as a third-party recipient or an email address associated with the consumer. The intermediary service may also aggregate or combine the multiple service responses related to a transaction into a single service response that it forwards to the consumer's mobile device and/or to another location. Alternatively, or additionally, a service provider may directly transmit a service response, (e.g., requested data), to the consumer's mobile device or to another location. In this way, the consumer or a third-party may receive a consumer service and service response, such as requested data, from the requester, a service provider, or another related party without having to provide personal contact information to the requester or a service provider. Furthermore, the consumer, who may have a more trusted “repeat” relationship with the intermediary service than he does with the requester or a service provider, may feel more confident that a transaction will not compromise the security of his mobile device and the data stored therein.

After receiving a consumer's authorization and/or forwarding service responses, the intermediary service sends an authorizing report to the request aggregator, which may forward the authorizing report to the point of request system. The authorizing report indicates whether the consumer has authorized some or all of the consumer services related to the transaction and/or applicable contracts, terms, etc. The report may also provide details about any related consumer services that were requested and provided. The service may not send an authorizing report if the transaction request indicated that an authorizing report is not required by the requester or applicable transaction processing rules. If the requester is a service target (e.g., an intended recipient of one or more service responses), then an authorizing report may be combined with one or more service responses in a single message to the requester.

After receiving service responses, the intermediary service may also send a transaction notification to the consumer's mobile device or another address associated with the consumer. The transaction notification provides details about any related consumer services that were requested and provided. The service may not send a transaction notification if it is not required by applicable transaction processing rules. Additionally, or alternatively, if the consumer is to receive one or more service responses (e.g., a data transfer), then the transaction notification may be combined with one or more service responses in a single message to the mobile device.

In some embodiments, the intermediary service may maintain a record of a set of contact addresses (e.g., phone numbers, email addresses, network addresses) associated with each consumer for the purpose of contacting a consumer when processing a transaction request. One or more addresses may be automatically selected for each transaction based on rules that are defined by the intermediary service, by the consumer, by a service provider, and/or by the requester. Alternatively, a consumer may be allowed to select an address from a list of addresses that are provided in an authorization message that is transmitted by the service to the consumer. In this way, the service may permit a consumer to customize his transactions, including how they interact with “smart” posters and similar advertising systems.

The intermediary service may also include a rules module that applies a set of rules for processing transactions. Each rule specifies one or more conditions to be tested and one or more actions to be executed based on the tests. For each transaction request, the service determines the applicable rules to apply and tests conditions for each rule. Based on the test results, the service either executes or does not execute an associated action related to a transaction. Conditions may be specified based on transaction information, consumer information, required services, service provider information, requester information, or other information. For example, a rule might specify testing whether the transaction involves the transfer of sensitive or protected data. Actions define the service's response to a particular result in testing a condition. To continue the previous example, the rule may include an action to specify an authorization procedure to carry out when the transaction involves the transfer of sensitive consumer information, such as medical records. Consumer-based rules provide another way of permitting a consumer to customize their transaction. Some rules apply to all transactions, regardless of the consumer initiating the transaction, while other rules apply to transactions from specified groups of consumers. Similarly, some rules apply to all consumer service requests, while other rules apply to only certain service providers and/or classes of consumer services. Rules may be specified by any participant in the transaction chain, including the consumer, the requester, a service provider, a third-party data recipient, and the intermediary service, or by a combination of rules from one or more of these parties.

When sensitive information is transmitted from a service provider through the intermediary service to the consumer's mobile device and/or another data recipient or transferee or other authorized party, the sensitive information may remain in an encrypted form that cannot be interpreted or used by the intermediary service. For example, the intermediary service may allow consumers to authorize a transaction involving the transfer of their medical records to a physician's office via the intermediary service. When those medical records are transmitted to the physician's office, only the intended receiving party has the necessary information to decrypt and use the received medical records.

Since the intermediary service processes multiple transaction requests for multiple consumers and maintains a centralized store of consumer information, the intermediary service may permit improved analysis of consumer transactions.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

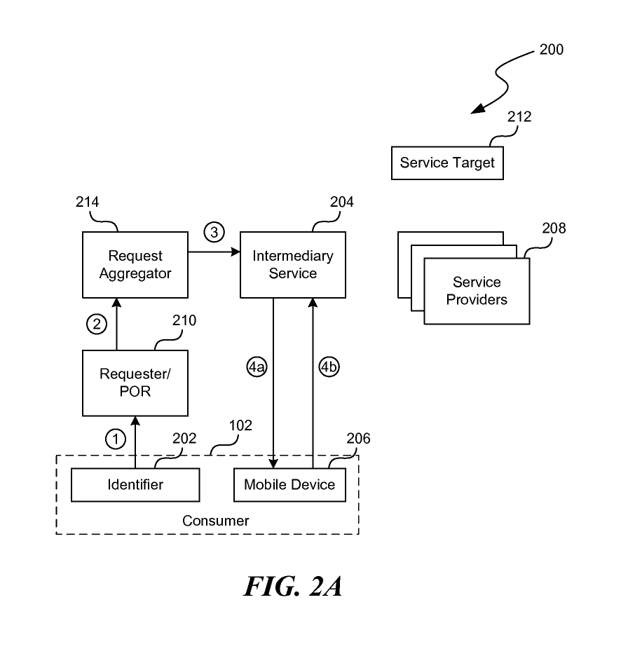

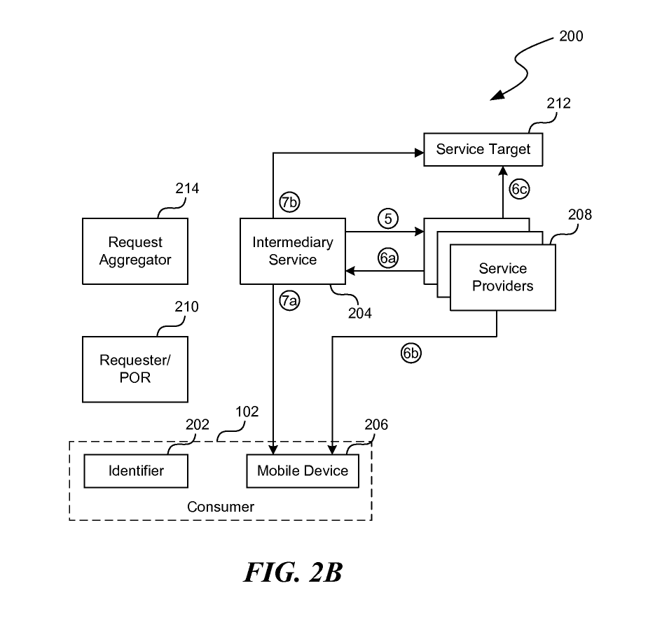

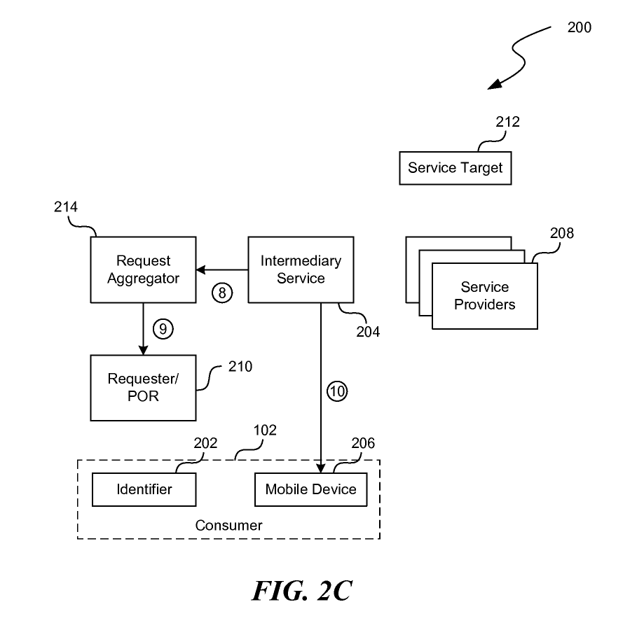

FIGS. 2A, 2B, and 2C illustrate an environment 200 in which an intermediary service 204 operates and depicts the order in which various modules involved in a transaction communicate in order to authorize the transaction and provide one or more consumer services related to the transaction. FIG. 2A is a block diagram that illustrates communication steps for initially processing a transaction request using an intermediary service. At step 1, a consumer 102 passively or actively provides an identifier 202 to the transaction requester at a point of request (“POR”) system 210. By doing so, the consumer requests consumer services and/or facilitates consumer authorization of a transaction.

As used herein, an “identifier” permits a point of request system, via a sensor, reader device, or other detection circuit, to discern that the consumer or an item associated with the consumer, such as the consumer's mobile phone, is proximate to the point of request system. In addition to indicating proximity to the point of request system, the identifier also provides identifying information about the consumer. A consumer is “proximate” to a point of request system if they are located within a specified distance and/or orientation with respect to the point of request system. In some examples, a consumer is “proximate” to a point of request system if the consumer can touch the point of request system (e.g., with a finger or identifier token). In other examples, a consumer is “proximate” to a point of request system if the consumer is within five meters of a point of request system. In still other examples, a consumer is “proximate” to a point of request system if the consumer is within two meters of a point of request. The identifier 202 may be issued by the intermediary service 204 or its operator. The identifying information embodied by an identifier may be an alpha-numeric code, a user-name, a sixteen digit number similar to a credit card number, a biometric pattern such as a fingerprint, or one or more pieces of data that may be used to identify the consumer.

In some examples, an identifier may be a radio frequency identification (RFID) tag embedded in a token or attached to a card or mobile device. In one example, the intermediary service 204 or another party provides an RFID identifier 202 or other identifier that is readily attachable to a user's mobile device 206, e.g., via a connector such as a fob, adhesive sticker, static film, etc. Non-exhaustive examples of other suitable identifiers include biometric identifiers (e.g., fingerprint signatures, heartbeat signatures, retinal signatures, voice signatures, etc.), a data signature, message, or code embedded in an intercepted radio frequency or other wireless signal (e.g., wireless signals emitted from the consumer's phone antenna and/or an NFC component in the phone), and a scannable optical pattern (e.g., a bar code).

A point of request system is any system or device that is configured to receive identifying information from a consumer's identifier that is proximate to the point of request system in order to facilitate the consumer authorization and/or consumer services for a transaction. Non-exhaustive examples of a point of request system 210 include a smart poster or advertising kiosk configured to deliver electronic advertising content, and a sales or service kiosk, register or handheld device. The point of request system may include a sensor or reader to detect a consumer's presence and obtain identifying information from nearby identifiers, such as an NFC reader (or other short-range reader), an RFID reader, a biometric sensor, or any other type of sensor or reader configured to detect and identify an individual consumer's presence and obtain identifying information from proximate identifiers. Alternatively or additionally, the point of request system may include input devices (e.g., a touch screen, keyboard, or microphone) that permit a user to actively enter identifying information about himself.

A consumer may actively or passively present an identifier to a POR system. The consumer may actively present an identifier to a POR system for example, by waving an RFID identifier near to, or tapping it on a portion of, the POR system. As another example, a consumer may actively present his finger to a biometric fingerprint sensor at a liquor store checkout stand so that the biometric fingerprint sensor can determine the consumer's identity for subsequent age verification. For identifiers that use longer-range detection technologies (e.g., identifiers with active RFID tags), the consumer may simply carry an identifier, for example in their wallet, and the POR system may detect and discern its identifying information automatically, with no physical intervention by the user. Similarly, for a remote biometric scanner, the user may simply need to stand near the POR system for the system to discern the identifiable biometric signature of the consumer.

Possible consumer services include, but are not limited to:
Ticketing services, including, e.g., tickets for air, rail, water, or other transportation; and tickets for sporting, music, arts, or any other type of ticketed event.
Loyalty program services, including frequent flyer programs, programs that provide financial or similar incentives to consumers (e.g., discount or rewards consumer programs) and other participating schemes that provide other types of non-financial benefits to consumers (e.g., virtual “check-in” services such as Foursquare, consumer review and communication services such as Digg, Yelp, and Zagat, and social networking services such as Facebook, MySpace, Twitter, or LinkedIn).
Document or data control services, such as providing digital signatures or digital rights management.
Access control services, such as key card control for homes, hotel rooms, cars, computer systems, or other buildings or systems.
Membership control services, such as company identification, club or organization membership identification, insurance coverage identification.
Identity verification services, including, e.g., identity verification for check-writing, citizenship or employment-eligibility; and age verification, e.g., to establish age-appropriateness for discounts, the purchase of restricted products such as alcohol, and/or admission to age-restricted venues.
Data transfer services, including, e.g., data transfer to a consumer or to a third-party of medical, dental, or other patient records or advertising media (e.g., advertising images, movie trailers, etc.).
Advertising services, including, e.g., providing advertisements and coupons to the consumer's mobile device.

Whether specified by a consumer or by a software process, the details associated with the consumer services may include, for example, an indication of the service providers who should provide the requested consumer services. For example, a consumer who approaches a POR system in order to purchase movie tickets may indicate that he wishes to use the POR system in order to provide verification of his age in order to qualify for a senior discount. Alternatively, or additionally, the POR system may indicate to the user (e.g., using an output device on the POR system, such as a screen) the nature of the consumer services that will result if the consumer provides his identifier to the POR system. For example, at a grocery store, the POR system may indicate that the POR system will use an identifier to retrieve applicable coupons.

A transaction requester (or simply “requester”) is an entity or individual who operates a point of request system 210 or otherwise utilizes a point of request system to obtain the consumer's request for consumer services and/or the consumer's authorization of a transaction. For example, a transaction requester may be a merchant of products and/or services; a ticketing agent; an advertising distributor; a corporation or similar business entity; a government, charity, academic or medical institution; or an individual person.

In step 2, the point of request system 210 generates a transaction request based on the received identifying information, point of request information, and transaction information and transmits the transaction request to a request aggregator 214. The point of request information sent to the request aggregator 214 may include, for example, one or more identifiers associated with the point of request system and/or the requester. The transaction information includes any information needed to obtain consumer authorization, including, for example, an address or identifier associated with applicable terms, policies, contracts, agreements, forms, or similar information for the consumer's acknowledgment and/or acceptance (i.e., authorization); and an indication of the type of authorization desired by the requester and/or the consumer. The transaction information further includes any information needed to carry out the one or more requested consumer services related to the transaction, including for example, codes or other content that indicates the type of consumer services requested by the consumer. In many examples, the transaction information will provide information for multiple consumer services associated with a single transaction, as described in greater detail herein. Furthermore, the transaction information may include an indication of the consumer's or requester's other inputs to the point of request system 210 (e.g., from a keyboard, touchscreen, input button, or similar input devices). As one example, when a transaction includes a data transfer service, the transaction information may include an address or identifier of data that should be transferred (e.g. an address or identifier of advertising, marketing or similar content); the type of data that is to be transferred (e.g., advertisement vs. medical records); a time for the transfer; and an address or identifier associated with a transferee or service target 212 who should receive the data. The service target 212 may be an address or location associated with the consumer (e.g., an email address, a phone number, a network address) or may be an address or location associated with a third-party (e.g., an email address, a phone number, a network address).

In some embodiments, the transaction request also includes a unique transaction identifier. The transaction identifier may be retained throughout the authorization process such that every participant or component can use it to identify the transaction.

The request aggregator 214 receives transaction requests from multiple point of request systems 210. A request aggregator 214 routes the received transaction requests to an appropriate intermediary service 204. The request aggregator 214 may also provide other functionalities such as altering transaction requests to conform to the requirements of the intermediary service 204, supplementing the transaction request with additional information, brokering intermediary services (e.g., identifying an appropriate intermediary service 204 to handle a particular transaction request), facilitating billing or charge-back for aggregation or intermediary services, and/or other functions. One having skill in the art will appreciate that the request aggregator 214 may be omitted from the sequence shown in FIGS. 2A-2C, and the point of request system 210 may instead interact directly with the intermediary service 204. In such examples, the intermediary service 204 may perform some or all of the aforementioned functionalities instead of the request aggregator 214.

In step 3, the request aggregator 214 sends at least part of the information from the original received transaction request and optionally additional information to the intermediary service 204 in another transaction request. The request aggregator is able to route the transaction request to the intermediary service 204 because the identifying information transmitted in the original transaction request identifies the transaction request as being associated with a consumer 102 having an account with the intermediary service 204. After receiving the transaction request from the request aggregator 214, as will be discussed in additional detail herein, the intermediary service 204 authenticates the request to ensure that the request has been issued from a valid request aggregator. Among other steps, the intermediary service 204 also retrieves consumer information associated with the transaction. The consumer information includes information for contacting the consumer 102, such as an address of a mobile device 206, telephone numbers, and email or network addresses. The consumer information may also include one or more verification codes that are each associated with the consumer, the identifier, a requester, and/or other parameters. The intermediary service 204 may also retrieve any applicable rules on how to process the received request.

After authenticating the transaction request from the request aggregator 214, at a step 4a, the intermediary service 204 may transmit an authorization message to a mobile device 206 that is associated with the consumer if the rules that are applicable to the consumer and the transaction require authorization. To illustrate, the rules may require an authorization message if the transaction involves the transfer of sensitive data, but may not require an authorization message if the transaction simply involves the transfer of advertising content. A consumer's authorization may be solicited for some or all of the requested consumer services related to the transaction. For example, if a transaction requestor requests both age verification and data transfer services during a transaction, the consumer's authorization may only be needed to authorize the data transfer. The age verification may not require consumer authorization to proceed.

The mobile device 206 may be a mobile phone, a smart phone, a media player (e.g., an Apple iPod, or iTouch), a mobile game device (e.g. a Nintendo GameBoy, a Sony PSP), a personal digital assistant (PDA), an email device (e.g., a Blackberry), or any other device that may send and receive wireless transmissions. The authorization message is transmitted over a communications channel to the mobile device, such as a mobile telecommunications and/or data channel. In some examples, the authorization message is sent via an XMPP message using the retrieved address of the mobile device. An XMPP message may be sent using a data channel, such as a data network implementing TCP/IP provided by a wireless service provider. Of course, any other messaging protocol may be utilized, including for example, SMS/MMS, Gale, IRC, Microsoft Live Messenger, PSYC, SIP/SIMPLE, Skype, YMSG, Zephyr Notification, and newly developed messaging protocols, and/or a message may be sent over other types of data networks that are not provided by a wireless service provider, including for example WiFi or similar wireless local area networks. The message may be sent to a standard TCP port, such as port 5222. The address utilized to send the message may be, for example, a telephone number, network address, or e-mail address associated with the mobile device 206 or any other address identifier. In some examples, at least the final leg in the communication channel used to deliver the authorization message to the mobile device utilizes a long-range wireless telecommunication and/or data protocol, such as UMTS, GSM, LTE, WiFi, or another long-range protocol, such as the protocols described previously. Typically, the authorization message is not delivered directly from the point of request system 210 to the mobile device 206 using a short-range communication protocol.

The authorization message includes transaction information such as the transaction requester or related information (e.g., a website, trade name, or product name associated with the requester); terms, policies, contracts, agreements or similar information that must be acknowledged or accepted (i.e., authorized) by the consumer; an indication of the one or more requested consumer services (including, for example, the service providers that will provide the requested consumer services); details relating to the provisioning of consumer services (e.g., data that will be transferred during the transaction; and/or an intended service target 212 or transferee of data). In particular, the authorization message may include information relating to any service targets so that the consumer can verify that the service targets should receive the data being transferred. The mobile device may use the service target information to enable the consumer to access additional information about the service target. In some embodiments, the intermediary service may also determine a list of pre-verified service targets; the consumer may then use the list to determine whether the service target should receive particular data. The authorization message may also include additional information related to the transaction, such as textual, graphical, audio or video data that would be useful to the consumer 102 when they review the authorization message and/or the message may include a link to such information. For example, the authorization message might provide the full text of a consumer contract and/or a link to the full text of a consumer contract. As another example, in the context of a ticketing transaction, the authorization message might indicate graphically where the consumer's seats are located in a venue and the price. In order to provide the additional information, the intermediary service 204 may request data (e.g., media content) from one or more service providers 208 when generating the authorization message (step not shown in FIG. 2A). The authorization message may also request that the consumer 102 provide information to continue the transaction, such as to provide an affirmative confirmation of the transaction, a consumer-specific, identifier-specific, service-provider-specific or other type of verification code, and/or a selection of a service target 212.

In the event that the intermediary service 204 is unable to transmit the authorization message to the mobile device 206, the intermediary service may support fallback methods for transmitting an authorization message to the consumer. For example, in the event that the intermediary service is unable to communicate with the mobile device using an XMPP-formatted message (or other types of messages such as JavaScript Object Notation, XML, or similarly-formatted messages), the service may also send the authorization message to the device using a short message service (“SMS”) message, an email message, or through another messaging channel. In some embodiments, the intermediary service may call the mobile device (if the mobile device has voice capability) and may use an Interactive Voice Response (“IVR”) system to solicit authorization from the consumer. If the mobile device 206 cannot be reached via any channel, in some embodiments the intermediary service 204 transmits the authorization message to a different device capable of receiving data messages that is associated with the consumer, such as a personal computer or other device authorized to perform this action. Alternatively, the intermediary service may attempt to communicate with the consumer through a land-line telephone. The intermediary service may maintain a prioritized list of fallback methods to use, and may proceed through the list until the authorization message is delivered to the consumer or until a certain period has elapsed and the service declares a delivery failure or takes other prescribed action, e.g., an action prescribed by rules applicable to a particular consumer, the intermediary service, a service provider, the transaction requester, a card issuer, etc.

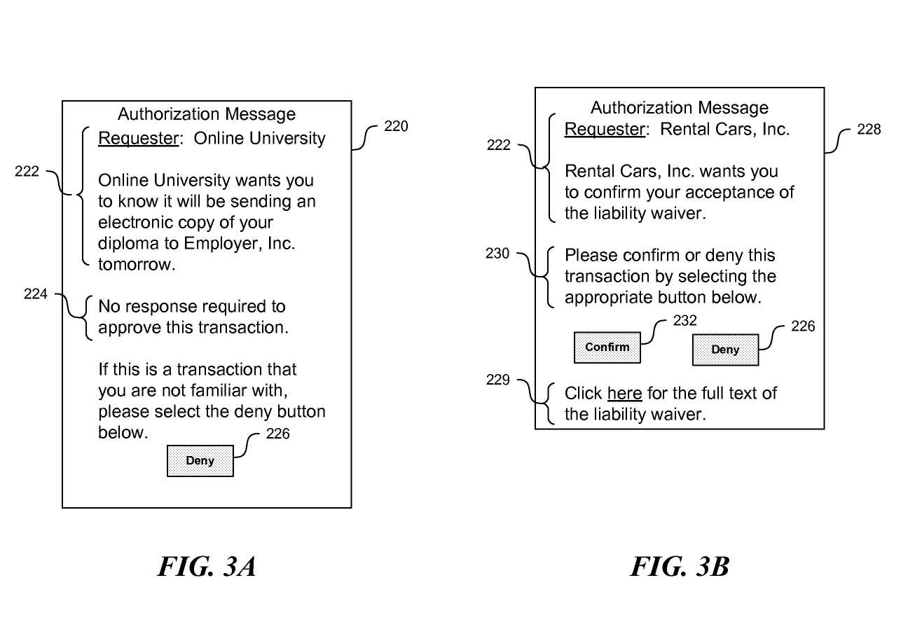

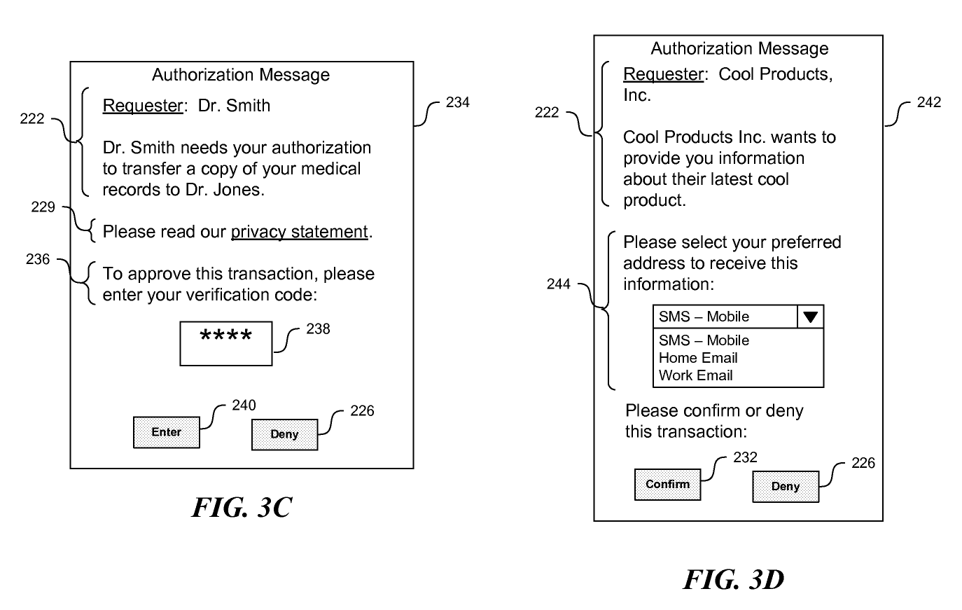

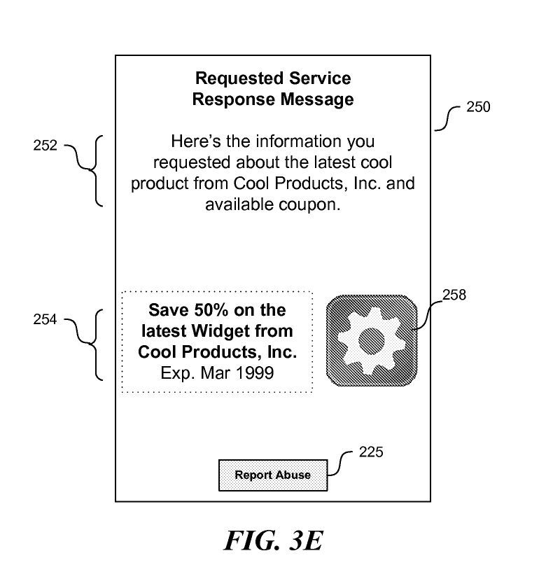

FIGS. 3A-3D are screenshots of representative authorization messages that may appear to a consumer 102 on his mobile device 206. Although the figures depict each example message separately, portions of the messages shown in FIGS. 3A-3D may in some cases be combined in a single message.

FIG. 3A depicts a screenshot 220 of a first representative authorization message. The authorization message includes a region 222 that contains details of the transaction, such as a requester (in the depicted example, “Online University”), an indication of the service being provided (e.g., data transfer), details of the service (e.g., the data being transferred as a result of the transaction (“an electronic copy of your diploma”), a service target 212 or recipient for a service response including the data (“Employer, Inc.”), and a time of service response/data transfer (“tomorrow”). For transactions that do not require the consumer's explicit authorization of a consumer service (e.g., a data transfer service) and/or transaction terms via an authorization response, the service may not require a consumer to confirm that the transaction should take place. In the depicted example, the authorization message therefore includes a message 224 to the consumer indicating that no response is required to authorize the transaction. If, however, the consumer is unaware of the transaction and therefore believes that the transaction may be a fraudulent or erroneous one, the consumer is presented with a “deny” button 226. By selecting the deny button within a specified time window, the consumer is able to notify the intermediary service 204 that the transaction is fraudulent or in error and thereby cause the intermediary service to terminate the consumer service and to notify the request aggregator of the denial.

FIG. 3B depicts a screenshot 228 of a second representative authorization message. The authorization message includes a region 222 that contains details of the transaction, such as a requester (in the depicted example, “Rental Cars, Inc.”). The region 222 also identifies, either directly or by reference, applicable transaction terms, policies, contracts, agreements, or other similar transaction information (in the depicted example, a “liability waiver”) that should be acknowledged or accepted (i.e., authorized) by the consumer in order to consummate the transaction. The authorization message may also include a region 229 that contains greater detail about the transaction. For example, the region 229 may include the full text or a selection from an applicable term, policy, contract, agreement, and/or a link to such additional information (e.g., “click here for the full text of the liability waiver”). The intermediary service 204 may require the consumer 102 to confirm his acknowledgment or acceptance of the information provided in order to authorize and consummate the transaction. In the depicted example, the authorization message therefore includes a message 230 to the consumer indicating that the consumer must confirm or deny the transaction. To confirm that the transaction is authorized, the consumer selects a “confirm” button 232. By selecting the confirm button, the consumer is able to notify the intermediary service 204 that the transaction should proceed. To deny the transaction, the consumer selects the “deny” button 226. Selecting the deny button notifies the intermediary service that the transaction is fraudulent, in error or that the consumer does not wish to proceed in light of the applicable terms, policy, contract, or agreement. By selecting the deny button, the consumer thereby causes the intermediary service to terminate the transaction and to notify the request aggregator of the denial. By clicking on a link to additional information, the consumer may cause the intermediary service to retrieve the requested additional information (e.g., the full text of a liability waiver) from one of the service providers 208 or elsewhere, generate a new authorization message containing the additional information, and send the new authorization message to the mobile device 206. Alternatively, the additional information may be displayed to the user via another application on the mobile device 206 (e.g., a web browser).

FIG. 3C depicts a screenshot 234 of a third representative authorization message. The authorization message includes a region 222 that contains details of the transaction, such as a requester (in the depicted example, “Dr. Smith”), the nature of the requested service (e.g., data transfer), and details regarding the requested service (e.g., the data being transferred as a result of the transaction (“a copy of your medical records”), and a service target 212 or recipient for the service response, including the data (“Dr. Jones”)). The authorization message may also include a region 229 that contains greater detail about the transaction (e.g., a link to an applicable privacy statement). For transactions that involve the transfer of sensitive data, the transfer of large volumes of data, require significant privacy concerns, or otherwise require rigorous verification of the consumer's identity, the intermediary service 204 may require the consumer 102 to confirm that the consumer service should take place and may require information that verifies the identity of the person confirming the transaction. The service may require similar confirmation and verification if the consumer is authorizing an important contract. In the depicted example, the authorization message therefore includes a message 236 to the consumer indicating that the consumer must enter a verification code. A text entry box 238 is provided, which displays a default character (e.g., “*”) as an additional security measure as the consumer keys in their verification code. After entry of the code, the consumer selects an “enter” button 240 to confirm that the transaction is authorized. By selecting the enter button, the consumer notifies the intermediary service that the transaction, including related consumer services (e.g., data transfer), is authorized and thus should proceed, provided that the verification code entered by the consumer matches the verification code that is associated with the consumer, the identifier, and/or the requester and stored by the service. To deny authorization of the transaction, the consumer selects the “deny” button 226. Selecting the deny button notifies the intermediary service that the transaction is fraudulent, in error or undesired and thereby causes the intermediary service to terminate one or more of the consumer services of the transaction (e.g., data transfer) and to notify the request aggregator of the denial.

FIG. 3D depicts a screenshot 242 of a fourth representative authorization message. The authorization message includes a region 222 that contains details of the transaction, such as a requester (in the depicted example, “Cool Products Inc.”) and the data being transferred as a result of the transaction (“information about their latest cool product”). Rather than displaying a service target 212 that will receive a service response (e.g., data) as a result of the transaction, the fourth authorization message includes a drop-down menu 244 that allows the consumer to affirmatively select the desired contact address at which the consumer or a third-party service target will receive a service response (e.g., transferred data) related to the transaction. For example, the consumer may select an “SMS-mobile” option to receive information on their mobile device by a short text messaging or multimedia messaging service (“SMS” or “MMS”), “Home Email” to receive the product information at the consumer's personal email account, and “Work Email” to receive the product information at the consumer's work email account. Once the consumer has selected the desired service target 212 to use in the transaction, the consumer then confirms that the transaction is authorized and should proceed by selecting the “confirm” button 232. By selecting the confirm button, the consumer is able to notify the intermediary service 204 that the transaction should proceed with the requested consumer service using the selected service target. To deny authorization of the transaction, the consumer selects the “deny” button 226. Selecting the deny button notifies the intermediary service that the transaction is fraudulent, in error, or not desired and thereby causes the intermediary service to terminate the consumer service (e.g., data transfer) of the transaction and to notify the request aggregator of the denial.

FIGS. 3A-3D show an authorization message that requests authorization for a single consumer service (e.g., data transfer). However, a transaction may involve two or more consumer services, of which multiple services may need consumer authorization to proceed. For example, a data transfer transaction requested by a consumer may require both age verification and data transfer services. In many examples, consumer authorization for multiple consumer services of a single transaction may be solicited in a single authorization message. In other examples, a consumer may receive two or more authorization messages, each of which is related to the authorization of a specific requested consumer service.

Returning to FIG. 2A, when required by the authorization message (such as required by the authorization messages in FIGS. 3B-3D), the consumer 102 uses the mobile device 206 to send an authorization response to the intermediary service 204. Such an authorization response is sent in a step 4b, and may confirm the transaction or deny the transaction described in the authorization message (or a specific consumer service associated with the transaction) and/or may provide additional information, such as a selected service target 212 (e.g., as shown in FIG. 3D). At least the first leg in the communication channel used to send the authorization response from the mobile device 206 utilizes a long-range wireless telecommunication and/or data protocol, such as UMTS, GSM, LTE, WiFi, or another long-range protocol, such as the protocols described previously.

Alternatively, the consumer 102 may confirm or deny the transaction (or a specific consumer service thereof) by other means (e.g., text message or voice verification) if fall-back methods were utilized to notify the consumer of the transaction. If the consumer denies the transaction, the intermediary service ends further processing of the transaction request and notifies the request aggregator 214 via an authorizing report that the transaction request has been denied, as described in greater detail herein with respect to step 8 of FIG. 2C. The request aggregator, in turn, may notify the point of request system 210.

If, however, no authorization message was sent at step 4a, the authorization message does not require an authorization response from the consumer (such as in FIG. 3A), or the consumer confirms his authorization of the transaction, the intermediary service 204 takes the additional steps shown in FIG. 2B to initiate the performance of the consumer services requested during the transaction. The steps shown in FIG. 2B are taken only if the transaction request indicates that a consumer service should be provided. For example, these steps may not be taken if the transaction request required only the consumer's acknowledgement of applicable terms. These steps may be taken after some delay, for example, if the consumer service is to be performed at a later time (such as in FIG. 3A).

At step 5, the intermediary service generates one or more service requests, each of which is used to initiate a consumer service associated with the transaction. If multiple consumer services were requested by the consumer (e.g., that are performed by multiple service providers 208), the intermediary service may generate multiple service requests. The content and format of a service request will be dictated by the nature of the consumer service being requested (e.g., a data transfer request versus an identification verification request) and the service provider to which the request is being directed. The content and format of a service request is also based on the transaction request, the consumer's authorization response, stored consumer information, stored requester information, and/or stored service provider information (e.g., information relating to application programming interfaces utilized by service providers). The service request should provide sufficient information to permit the service provider to perform a requested service. As an example, the service request may include an indication of the service that is requested, as well as an indication of the type of content, format, and/or delivery mechanism for a service response that the service provider should produce. The service request may also include authentication information (e.g., a stored username, password, and/or certificate, etc.) that may be associated with the intermediary service 204, requester 210, and/or consumer 102. To illustrate, for a data transfer service, the service request may include the identity, location, or logical address of the requested data and optionally, an address associated with a data recipient, such as a service target 212 or the mobile device 206.

At step 5, the intermediary service 204 transmits the one or more service requests to one or more service providers 208.

At step 6a, each of the service providers 208 receiving a service request uses the service request to take steps necessary to provide the requested consumer service and to generate and transmit a suitable service response. The service response may be transmitted to the intermediary service 204, mobile device 206, and/or another service target 212, which in some examples, may be the requester 210. The content and format of the service response will be dictated by the nature of the consumer service being requested (e.g., ticketing request versus a data transfer request versus an identification verification request), the contents of the service request made, the service provider, and/or the recipient of the service response. For example, if the service request specified a data transfer service, the service provider may identify and access the data related to the transaction and transfer, via a service response, a copy of the requested data to the intermediary service 204 (shown at step 6a), the consumer's mobile device 206 (step 6b), and/or to another service target 212 (step 6c). As another example, if a service request has asked for age verification, the service provider may identify and access data related to the consumer's age and send the virtual drivers license to the requestor or send a service response that indicates the consumer's age and/or indicates whether the consumer has attained a certain age of majority.

If the requested service response is sent to the intermediary service as shown at step 6a, the intermediary service 204 may relay the service response to the mobile device 206 (as shown at step 7a) and/or another service target 212 (step 7b) via another service response message. For example, for a data transfer service, the intermediary service 204 may transfer a service response comprised of requested data to a personal email address associated with the consumer 102 or a third-party. In the event that multiple service responses that relate to a single transaction are received by the intermediary service (e.g., if multiple consumer services were requested during a single transaction), then the intermediary service may aggregate two or more service responses received into a single expanded service response that it forwards to the service target 212 and/or mobile device 206.

The intermediary service 204 may provide the service response in a format suitable for delivery to the mobile device 206 or another service target 212. For example, the data may be transmitted to the mobile device via a data transfer message in an XMPP format or other messaging format (as described previously) using the retrieved address of the mobile device. In some examples, at least the final leg in the communication channel used to send the service response from one of the service providers 208 or from the intermediary service 204 to the mobile device 206 utilizes a long-range wireless telecommunication and/or data protocol, such as UMTS, GSM, LTE, WiFi, WiMax or another long-range protocol, such as the protocols described previously.

FIG. 3E depicts a screenshot 250 associated with a representative service response message that may be sent to the consumer's mobile device 206, e.g., in response to a request for product information and/or a request for a coupon and/or a promotional message. As shown, the example message includes textual content 252 and image content 258 relating to a product as well as promotional or coupon information 254. The message also includes a button 225 for reporting abusive or unwanted data to the intermediary service 204. A data transfer message may include any type of data, including, for example, textual, image, audio or video data.

FIG. 2C illustrates a process for providing an authorizing report and notification message for a transaction. At step 8, the intermediary service 204 generates an authorizing report and sends the authorizing report to the request aggregator 214. The authorizing report reflects whether the consumer has authorized the transaction or a portion of it. For example, if no authorization response was required to authorize the transaction, the authorizing report may simply indicate that the transaction was authorized. As another example, the authorizing report may indicate whether the consumer returned an authorization response at step 4b and whether that authorization response indicated a confirmation or denial of the transaction. Additionally, or alternatively, the authorizing report may include information indicating the details from one or more service responses (e.g., for a data transfer service the message might indicate what data was transferred (or provide a copy of the data), the service target, the time of transfer to a service target 212 and/or mobile device 206). This information may be provided in lieu of forwarding a separate service response to the requester. At step 9, the request aggregator 214 may relay the authorizing report to the point of request system 210.

At step 10, if required by applicable transaction processing rules, the intermediary service 204 may generate a notification message and provide the notification message to the mobile device 206. The notification message reflects the details of the consumer service provided to a service target 212 and/or mobile device 206. The notification message may include information from one or more service responses; this additional information may be provided in lieu of separately forwarded service responses. In some examples, at least the final leg in the communication channel used to send the notification message to the mobile device utilizes a long-range wireless telecommunication and/or data protocol, such as UMTS, GSM, LTE, WiFi, or another long-range protocol, such as the protocols described previously.

Although not shown, the intermediary service may log or otherwise record the progression or status of a transaction request through the various steps shown in FIGS. 2A through 2C. For example, the intermediary service may log some or all details of the transaction request received, the authorization messages sent, the authorization responses received, the service requests made, the service responses received, the authorizing reports sent, and/or the transaction notifications sent. The intermediary service may receive some indication from a service provider of the nature of a service response, regardless of whether the service response is relayed through the intermediary service, or whether the intermediary service is capable of reading the contents of the services response. For example, if the service response includes a data payload (e.g., an image) that is directly transferred to the mobile device 206 from one of the service providers 208, the intermediary service 204 may still receive an indication from the service provider that the data was transferred and might log that a successful data transfer occurred. By logging this information, the intermediary service is able to mine the logged information for insights into consumer behavior, to troubleshoot problems within the intermediary service and/or service providers, and/or to provide consumers with historical transaction information.

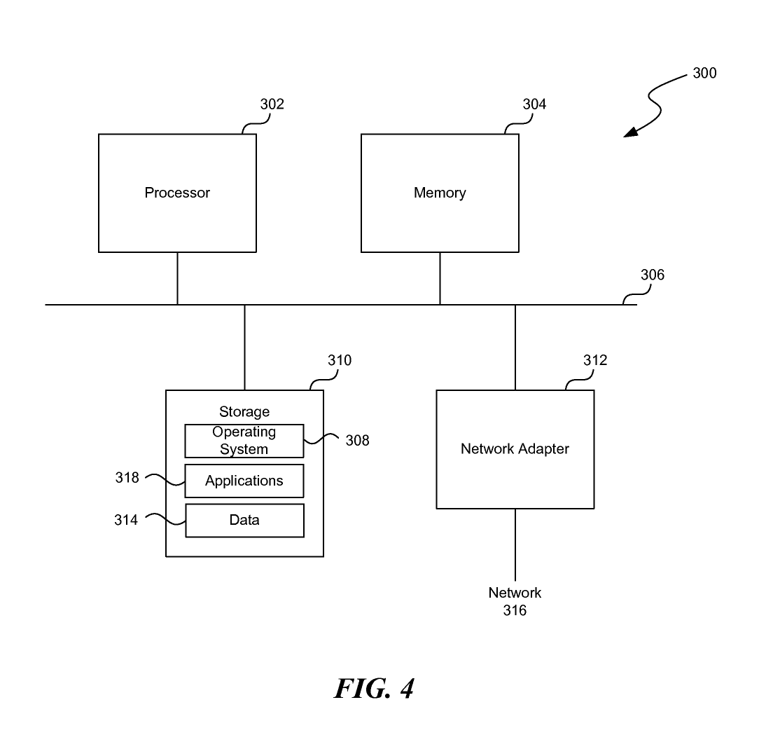

FIG. 4 is a high-level block diagram showing an example of the architecture of a server 300. One or more servers 300 may be utilized by, for example, the intermediary service 204 or the request aggregator 214 to implement the transaction processing depicted in FIGS. 2A-2C. The server 300 includes one or more processors 302 and memory 304 coupled to an interconnect 306. The interconnect 306 shown in FIG. 4 is an abstraction that represents any one or more separate physical buses, point-to-point connections, or both connected by appropriate bridges, adapters, or controllers. The interconnect 306, therefore, may include, for example, a system bus, a Peripheral Component Interconnect (“PCI”) family bus, a HyperTransport or industry standard architecture (“ISA”) bus, a small computer system interface (“SCSI”) bus, a universal serial bus (“USB”), IIC (12C) bus, or an Institute of Electrical and Electronics Engineers (“IEEE”) standard 1394 bus, sometimes referred to as “Firewire.”

The processor(s) 302 may include central processing units (CPUs) of the server 300 and, thus, control the overall operation of the server 300 by executing software or firmware. The processor(s) 302 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices. The memory 304 represents any form of random access memory (RAM), read-only memory (ROM), flash memory, or the like, or a combination of such devices.

The software or firmware executed by the processor(s) may be stored in a storage area 310 and/or in memory 304, and typically includes an operating system 308 as well as one or more applications 318. Data 314 utilized by the software or operating system is also stored in the storage area or memory. A network adapter 312 is connected to the processor(s) 302 through the interconnect 306. The network adapter 312 provides the server 300 with the ability to communicate with remote devices, such as clients, over a network 316 and may be, for example, an Ethernet adapter.

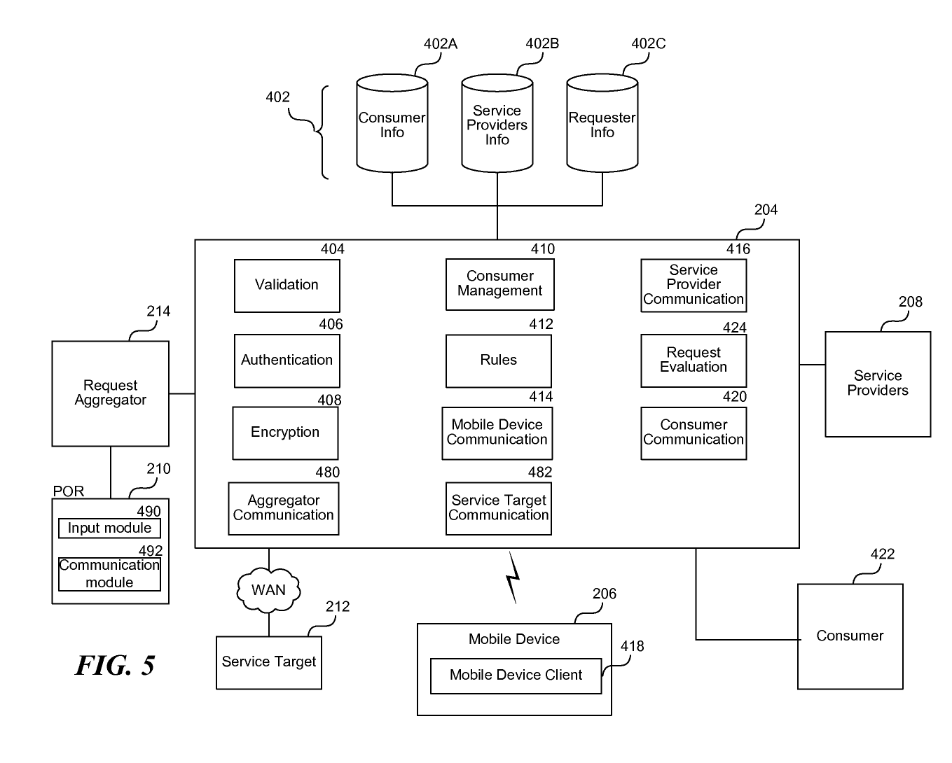

FIG. 5 illustrates a logical block diagram of the intermediary service 204. As discussed above, the intermediary service 204 receives a transaction request from the request aggregator 214 and executes additional steps to request consumer authorization of the request, receive the consumer's authorization of the transaction, initiate consumer services related to the transaction, provide service responses from service providers to a service target 212 and/or the consumer's mobile device 206, provide an authorizing report to a point of request system 210, and provide a notification message to the consumer 102. Aspects of the intermediary service may be implemented as special purpose hard-wired circuitry, programmable circuitry, or as a combination of these. As will be described in additional detail herein, the intermediary service 204 includes a number of modules to implement the functions of the intermediary service. The modules and their underlying code and/or data may be implemented in a single physical device or distributed over multiple physical devices and the functionality implemented by calls to remote services. Assuming a programmable implementation, the code to support the functionality of the intermediary service may be stored on a computer readable medium such as an optical drive, flash memory, or a hard drive. One skilled in the art will appreciate that at least some of the individual modules may be implemented using application-specific integrated circuits (ASICs), programmable logic, or a general-purpose processor configured with software and/or firmware.

As previously described, the intermediary service 204 receives a transaction request from the request aggregator 214 and after processing the request, provides the request aggregator with an authorizing report. In turn, the request aggregator 214 communicates with a point of request system 210. The point of request system 210 includes an input module 490 configured to receive unique identifying information from a consumer's identifier, and a communication module 492 configured to communicate with the request aggregator, typically over a WAN such as the Internet. The input module 490 may also be configured to receive other inputs from a consumer or requester, such as a specification of parameters associated with the requested transaction. In one example, the input module 490 comprises an RFID reader and the communication module 492 comprises an IEEE 802.11 network adapter.

The intermediary service 204 transmits one or more service requests to one or more service providers 208 and may receive one or more service responses from the service providers in response to the service requests. The intermediary service 204 also communicates with a mobile device 206 to request authorization for a transaction, receive the consumer's authorization of the transaction, transfer a service response to the consumer's mobile device 206, and provide a notification message. The intermediary service 204 also interacts with a service target 212 (e.g., over a WAN) to transfer a service response to the service target.

The intermediary service 204 also interacts with a storage component 402, which is configured to store configuration information, consumer information 402A, service providers information 402B, and requester information 402C. In particular, the storage component 402 stores consumer information 402A linking the identifying information received from the request aggregator 214 to consumer-specific account information, such as an address of the mobile device 206, other addresses associated with the consumer (e.g., land-line phone numbers, email addresses, network addresses), a verification code or codes associated with the consumer, the identifier, and/or the requester. The consumer information 402A may also include consumer-specific transaction processing rules and/or consumer-specific transaction history or metadata information. The consumer information may include service and account linking information that specifies which service providers a consumer utilizes for different consumer services. The service linking information may also include consumer-specific information related to the various service providers utilized by the consumer, such as (1) user-specific account information for a service provider, (2) user-specific preferences or settings for a service provider (including, e.g., locations where user-specific data is stored), and/or (3) user credentials (e.g., username or password) necessary to receive the services from a service provider. As an example, the consumer information may indicate the name of the consumer's airline, and provide account details, such as tickets, boarding passes, frequent flyer numbers and the like. As another example, the consumer information may provide information about which medical offices have medical records related to the consumer. The precise nature of consumer-specific information that is stored will depend on the types of consumer services that the consumer will access via the intermediary service.

The storage component 402 may store service providers information 402B, including information that assists the intermediary service in formulating service requests, including for example, application programming interfaces utilized by various service providers 208 or transaction processing rules that are specific to a certain service provider. The storage component 402 may also store information that maps various service providers 208 to different consumer services. The storage component 402 may also store requester information 402C, which may for example, permit the intermediary service to authenticate transaction requests and/or interpret transaction requests. For example, the requester information 402C may correlate a promotional identifier or a point of request identifier provided in a field of a transaction request to a specific file (e.g., an advertising image) managed by a specific service provider.

The intermediary service 204 includes various modules to assist in processing transaction requests. In particular, the intermediary service 204 includes an aggregator communication module 480, which is configured to communicate with the request aggregator 214. For example, the aggregator communication module 480 may be utilized to receive a transaction request from and send an authorizing report to the request aggregator 214.

The intermediary service 204 includes a validation module 404, which is configured to receive transaction requests and validate that the requests are correctly formed. Validating transaction requests may include, for example, verifying that the request is correctly structured and includes all of the required data fields. In some embodiments, the transaction request is specified in extensible markup language (XML). In these embodiments, validation includes determining that the XML is well-formed.

The intermediary service 204 also includes an authentication module 406, which is configured to authenticate the sender of the transaction request (the request aggregator 214 and/or point of request system 210). The authentication module 406 is also configured to authenticate the mobile device 206 and/or consumer, e.g., using hardware identifiers such as a service-subscriber key (e.g., international mobile subscriber identity), integrated circuit card identifier, or other identifier stored or generated by a subscriber identification module (SIM) or similar; an International Mobile Equipment Identity (IMEI); client certificates; encryption keys; etc. Authentication is used to avoid having an imposter pose as a legitimate request aggregator 214 for the purpose of submitting unsolicited or fraudulent service requests. The authentication module 406 may authenticate the request aggregator 214 and/or point of request system 210 using methods well known in the art. For example, the authentication module 406 may be configured to verify a digital signature associated with the request aggregator and contained in a transaction request or in an authentication exchange completed prior to receiving a transaction request. Alternatively, the authentication module 406 may be configured to authenticate the request aggregator by using a shared encryption key to decrypt a portion of the data in the transaction request. To do so, the authentication module 406 interacts with an encryption module 408, which is configured to execute an encryption algorithm that is complementary to an encryption algorithm that is used by the request aggregator 214. The encryption module 408 may also be used to encrypt messages sent from the intermediary service 204 to the mobile device 206, one of the service providers 208, and the service target 212. In some embodiments, the encryption module 408 also decrypts messages received from a service provider, or the mobile device 206 and encrypts messages sent to the request aggregator 214. In some examples, the encryption module may also act as a key server to permit direct encrypted connections between the POR, service target, mobile device, and/or service providers.

The intermediary service 204 includes a consumer management module 410, which is configured to manage consumer information 402A, including retrieving consumer information associated with a transaction request. The consumer information 402A is accessed from the storage component 402 based on the unique identifying information contained in the transaction request. As discussed above, the identifying information may be, for example, an alpha-numeric code, a sixteen digit number similar to a credit card number, or one or more pieces of data that uniquely identifies the consumer (e.g., a consumer nickname or biometric signature). The stored consumer information includes information for contacting the consumer 102, such as an address of a mobile device 206 that is associated with the consumer, telephone numbers associated with the consumer 102, and email or network addresses associated with the consumer 102. The stored consumer information also includes a verification code or codes that are associated with the consumer, the identifier, and/or the requester, and/or other consumer-specific information, as described above.

After the consumer management module 410 retrieves the stored consumer information 402A, stored service providers information 402B, stored requester information 402C, and/or other information stored in the storage component 402, a rules module 412 determines and applies transaction processing rules to determine the intermediary service's response to the transaction request. In some embodiments, the rules module 412 is configured to determine the type of authorization message to provide to the consumer's mobile device 206 and the required level of consumer response to the authorization message needed to confirm their authorization of the transaction. The type of authorization message may vary depending on the consumer, the types of consumer services requested or details of the consumer services request (e.g., the type and/or volume of data being transferred as a result of a consumer service request, the service provider utilized, the requester, and other factors). For example, at lower levels of sensitivity (e.g., the transfer of advertising data from a data transfer service to a consumer's mobile device at the behest of a “trusted” requester), the intermediary service may be configured to request the data in a service request and send the resultant service response (including the requested data) automatically to the mobile device without previously sending an authorization message. At higher levels of sensitivity (e.g., if the transaction involves the transfer of non-sensitive data to a third-party service target) the intermediary service may be configured to send an authorization message to the mobile device 206 before requesting a consumer service from a service provider, but may not require any response from the consumer and may proceed with the service request if no negative response is received from the consumer within a certain time period after the authorization message is sent. At still higher levels of sensitivity (e.g., the consumer's acceptance of an important contract), the intermediary service may require that the consumer reply to the authorization message with a response that either authorizes or denies the transaction, and possibly require that the consumer provide a correct verification code with the response.

When a transaction involves two or more consumer services, the rules module may determine whether authorization is needed before requesting each of the consumer services; this determination may be made by applying rules that are specific to the various consumer services and/or the consumer. The rules module may also determine whether a consumer should receive an aggregated authorization message that relates to two or more consumer services, or whether the consumer should receive multiple authorization messages, each relating to a different consumer service. The rules module may also determine the order in which to solicit consumer authorization of various consumer services and/or the interrelationships or dependencies between the various authorizations. For example, a consumer who during a single transaction has requested both age verification and data transfer services may receive a single authorization message soliciting permission for both services. In other examples, the consumer might receive (1) a first authorization message requesting permission to provide the consumer's age to a specified service target, and (2) a second authorization message requesting permission to transfer the data. The rules module may require that an authorization response is received in response to the first authorization message before sending the second authorization message.

Such rules regarding authorization and other steps may be defined by the operator of the intermediary service, by requesters that interact with the intermediary service, by service providers 208, and/or by consumers that use the intermediary service. While three sensitivity levels are provided as an example, it will be appreciated that a greater or lesser number of levels may be utilized by the intermediary service.

The rules module 412 may also determine and apply transaction processing rules that specify where, when and how to send authorization messages, make a service request and/or forward a service response to the mobile device 206 and/or a service target 212. For example, the rules module 412 may dictate a delivery order and dependencies or criteria for coordinating multiple service requests and service responses associated with a single transaction. For example, if both age-verification and data transfer services are required for a transaction, the rules module might mandate that an age-verification service provider provide a first service response indicating the consumer's age before the intermediary service will generate a data transfer request. In some examples, the rules module might further specify that an aggregated service response should be sent to the consumer (reflecting the outcome of both the age-verification and data transfer services), but only after a second service response is received from the data transfer service provider.

If existing service-, requester-, or consumer-defined rules do not already specify a service target 212 that should receive a service response to a given service request, the rules module 412 may also require that the consumer select one or more service targets to use for the transaction in an authorization response. If existing service-, requester-, or consumer-defined rules do not already specify other necessary details of a transaction, the rules module 412 may also require that the consumer provide the missing information to use for the transaction in his authorization response.

In general, the rules module 412 stores a set of transaction processing rules in the storage component 402. Each rule includes information specifying a consumer or group of consumers to which the rule applies, a set of conditions that must be met for the rule to be satisfied, and associated actions that are taken when the rule has been satisfied. In the simplest case, a rule identifies a particular consumer whose transactions will be subject to the rule. However, a rule may also apply to groups of consumers (e.g., for requester-defined rules), or to all consumers (e.g., for service-defined rules). Whether a rule applies to a single consumer, to a group of consumers, or to all consumers may be specified by a code or other mapping to a list of consumers that the intermediary service maintains. Each rule may also include information specifying a specific service provider or group of service providers to which the rule applies, permitting even further customization of rules to different service providers. Whether a rule applies to a single service provider, a group of service providers, or to all service providers may be specified by a code or other mapping to a list of service providers that the intermediary service maintains. In some embodiments, an individual consumer is allowed to create additional rules that apply to the consumer's account and/or to specific service providers utilized by the consumer. For example, the intermediary service may allow a consumer to create rules specifying preferred data delivery addresses. As another example, the intermediary service may allow a consumer to create rules specifying preferred or blocked service providers 208 for various consumer services. As another example, the intermediary service may allow a consumer to create rules that automatically authorize transactions from “trusted” requesters or to authorize services provided by “trusted” service providers 208 without any consumer authorization or confirmation.

The set of conditions for a rule defines a set of tests that the rules module 412 evaluates each time it evaluates the rule. In order for the rule to be satisfied, all of the conditions specified by the rule must be met. Each condition tests one or more factors. The factors tested may include binary factors (factors having a “true” or “false” value), factors having a numerical value (e.g., numbers falling within a range from 1-100); factors having a range of non-numeric values (e.g., high/medium/low), factors having a textual value (e.g., if a particular string equals a requester name), or any other value that may be tested. A rule may connect multiple conditions using Boolean connectors (e.g., AND, OR, or NOT operators) in order to determine whether the rule has been satisfied in the applied situation. For example, the system could apply a rule for a consumer that prefers to receive product advertisement data on a personal email address unless it is from a vendor (e.g., Office Max) that regularly sends him coupons for the office. Such a rule may be phrased as follows:

IF (data_type = advertisement AND requester = Office Max)

THEN (apply <business_email_address>)

ELSEIF (data_type = advertisement AND NOT(requester = Office Max))

THEN apply <home_email_address>)

The intermediary service could also execute a different authorization and confirmation procedure depending on the type of consumer services that have been requested, the service providers 208 needed to consummate a transaction, and/or details of a consumer service request, such as the type of data that is being transferred as a result of a service request. Such a rule may be phrased as follows:

IF (data_type = advertisement or service_provider =
trusted_provider or

service_provider_type=advertiser) THEN (apply < Confirmation
Procedure 1>) ELSE

IF (data_type = personal_info) THEN (apply < Confirmation
Procedure 2>) ELSE

IF (data_type = HIPAA OR data_type = SSN)

THEN (apply < Confirmation Procedure 3>)

Alternatively, or additionally, the intermediary service could also execute a different authorization or confirmation procedure depending on the degree to which a requester wants proof of the consumer's authorization of transaction policies, terms, contracts or agreements. Such a rule may be phrased as follows:

IF (contract_type = warranty_info)

THEN (apply <Confirmation Procedure 1>) ELSE

IF (contract_type = video_rental_policy)

THEN (apply <Confirmation Procedure 2>) ELSE

IF (contract_type = liability_release)

THEN (apply <Confirmation procedure 3>)

In one example, a consumer may specify rules that define authorization requests, service requests, and/or notification procedures that occur on a scheduled, recurring or otherwise automated basis. For example, a consumer may establish a rule that if it is the first Monday of the month, the intermediary service should request the consumer's authorization of an automated mortgage payment, and if an authorization response is received, send a service request to an ACH processor for the mortgage payment, and then notify the consumer of the outcome of the service request. Such transaction requests may require no further action by a consumer; for example, the consumer may not need to approach a POR terminal to initiate the transaction. Such a rule might be phrased as follows:

IF (current_date=first_monday) THEN (apply<Mortgage Payment Procedure>)

As another example, a consumer may choose to delay or schedule certain consumer services until a specified time. For example, a consumer may wish to receive advertising materials after work hours, even if the materials were requested during a workday at a POR.

IF (current_time=workday and service_type=advertising delivery) THEN (apply<Delayed Delivery Procedure>)

Other conditions that the intermediary service could support are discussed in greater detail below.

Each rule also specifies a set of actions to be executed based on the results of evaluating the conditions. In some embodiments, each rule includes a single action that is executed when the conditions are met and not executed when the conditions are not met. Alternatively, the intermediary service may define multiple actions that are selected based on the results of testing the conditions and may define contingencies and/or interdependencies between those defined multiple actions. An action may be simple, such as denying authorization for the transaction request, or more complicated, such as specifying an authorization procedure to be executed, or specifying an order in which to handle multiple service requests and multiple service responses. The rules module 412 may be configured to execute each action immediately. However, because the intermediary service will often test multiple rules for each transaction request, the rules module 412 generally tracks the actions to be performed and executes the action(s) after testing all applicable rules.

In some embodiments, a consumer, requester, service provider, or the intermediary service may specify a time interval during which the rule is active. Each rule with a specified time interval is evaluated only during the time interval and is not evaluated at other times. By allowing a rule to be activated for certain time periods and deactivated for other time periods, a rule may be flexibly tailored to different circumstances.

One skilled in the art will appreciate that a wide variety of rules can be defined using information that is managed by, or accessible to, the intermediary service. In particular, conditions may be defined to evaluate transaction information, consumer information, service provider information or other intermediary service information. Examples of factors that may be considered when defining a condition include:
The location of the point of request and/or the requester (e.g., whether the location is within a particular geographical area),
The type of identifier utilized to initiate a transaction,
The time and/or distance from the last transaction or from a combination of recent transactions,
The consumer's historical transaction activity,
The types and mix of consumer services, service providers, and/or service targets implicated by a service request,
Details of a requested consumer service. For example, for a data transfer transaction, the details might include the type or volume of data that will be transferred (e.g., credit card information versus advertising content, video file versus executable file),
The requester type (e.g., advertiser, grocery store, pharmacy), and
Other details of the transaction, e.g., the types of tickets or other particular items purchased,
The transaction time.

Similarly, the intermediary service may support a variety of actions that can be executed based on the result of evaluating a rule. Examples of actions that may be defined include:
Blocking a particular requester,
Authorizing or not authorizing the transaction,
Specifying one or more authorization procedures that are executed as part of the transaction (e.g., specifying whether the consumer must provide a verification code), including whether and how authorization messages are sent to the mobile device and the content of those authorization messages,
Selecting one or more mobile devices to receive an authorization message,
Selecting one or more service providers 208 to fulfill the transaction,
Specifying the contents or format of service requests, and other details of service requests,
Selecting one or more service targets 212 or recipients to which a service response should be sent,
Specifying the method for ordering, aggregating, or otherwise handling multiple service requests sent to and multiple service responses received from different service providers 208, including defining any dependencies that exist between different consumer services implicated by the transaction,
Specifying whether authorizing reports are sent to the requester and the content of those authorizing reports,
Specifying whether and how a notification message is sent to the mobile device and the content of those notification messages,
   The “selecting a service target” action enables a consumer or rule to specify where service responses (e.g., data) should be sent in specified situations, e.g., an address associated with the consumer or a third-party. Similarly, the “selecting a mobile device” action allows a consumer to specify that multiple notifications should be sent for some transactions (e.g., a message to a first device requesting authorization and a message to a second device containing a service response but not requesting authorization).

The intermediary service may also maintain a transaction history that tracks or logs transactions and related semantic metadata for a consumer account over a period of time. The intermediary service can use the transaction history information or metadata to provide or develop rules that can respond to transactions that deviate from the usual patterns for the consumer account. For example, rules may be defined to detect when transaction requests are initiated at a physical point of request that is geographically distant from other transaction requests for the consumer.

The intermediary service 204 also includes a mobile device communication module 414, which is configured to communicate with mobile devices 206. The mobile device communication module 414 generates and transmits an authorization message in response to the transaction request and generates and transmits a notification message after data transfer.

The authorization message includes transaction information such as the requester and/or service provider, or related information (e.g., a website, trade name, or product name associated with the requester or service provider); terms, policies, contracts, agreements or similar information that must be acknowledged or accepted by (i.e., authorized by) the consumer; and an indication of the details of requested consumer service (e.g., data that will be transferred as a result of the transaction). The authorization message may also include additional information related to the transaction, such as textual, graphical, audio or video data that would be useful to the consumer 102 when they review the authorization message, and/or the message may include a link to such information. The authorization message may also specify a service target 212 to use for the transaction or specify a list of service targets and request a selection from the list. The authorization message may be sent to the mobile device in a variety of messaging formats, as described previously. In some embodiments, the authorization message is transmitted to mobile devices 206 via an asynchronous XMPP message or similar. To allow a mobile device to receive an XMPP-encoded message (or another type of message), the mobile device includes a mobile device client 418 that runs in the background of the device. The mobile device client 418 may be pre-installed on the mobile device 206, or may be downloaded to the mobile device 206 when a consumer opens a consumer account with the intermediary service. In some examples, the mobile device 206 will often operate in a standby or low-power mode in order to preserve battery power. In these embodiments, the mobile device client 418 cannot be operated continuously. Instead, the intermediary service 204 sends a network initiated wake-up message to the mobile device client 418 before sending an authorization message. The wake-up message may be transmitted on a different messaging channel, such as via a binary SMS message or via a WAP push message or other network based remote push service. In other embodiments, the mobile device client 418 operates continuously, since it is impossible to predict when a consumer might initiate a transaction request. In these embodiments, the mobile device 206 remains in a state where it always can receive an authorization message.

Once the intermediary service has determined that the transaction request has been authorized by the consumer, in accordance with applicable transaction processing rules, a service provider communication module 416 generates a service request based on the received transaction request (including requested services); stored consumer, requester, and/or service provider information; and the information received from the mobile device 206 in the authorization response (if any). In particular, in the case of a data transfer service, the service request may include an address associated with a service response recipient such as a service target 212 or mobile device 206 and the identity, location, or logical address of requested data. Of course, the content and format of the service response will vary, based on the type of service requested, the service provider, and the consumer. The service provider communication module 414 may encrypt the service request using the encryption module 408 and transmit the service request to a service provider where the service request is processed.

Upon receipt of the service request, the service provider may take proactive steps to perform the requested service. After a service request is processed by the service provider, the service provider communication module 416 receives a service response from the service provider. The service response may include any type of data, including, for example, advertising content (e.g., text, images, audio, video) or information about the consumer such as identifying information. In some examples, the service response provides an indication of the status of the consumer service request. For example, the service response may indicate that a data transfer gateway successfully transferred the requested data. The content and/or format of a service response will vary depending on the consumer service requested, the service provider, and/or other factors. If multiple service requests are made, the service provider communication module 416 may receive multiple service responses.

After receiving a service response, the intermediary service 204 forwards the received service response to the service target 212 and/or mobile device 206. In accordance with applicable data processing rules, the intermediary service may also take other actions after receiving a service response, such as holding a service response until other service responses are received from other service providers and/or aggregating service responses received from different service providers into a single service response. The service target communication module 482 may convert the received service responses into a format suitable for transmission to the service target, e.g., over a WAN. The format utilized may depend on the type of messaging or communication channel utilized to communicate with the service target (e.g., SMS versus email message). Similarly, the mobile device communication module 414 may convert the received service response into a format suitable for transmission to the mobile device 206 (e.g., an XMPP message). In some embodiments, the service response is encrypted by the service provider such that it can only be decrypted by the service target 212 and/or mobile device 206. Alternatively, the received service response may be decrypted by the intermediary service 204 and re-encrypted for transmission to the service target 212 and/or mobile device 206.

The intermediary service 204 may then utilize the aggregator communication module 480 to generate an authorizing report to the request aggregator 214, as described previously.

The mobile device communication module 414 may then generate a notification message summarizing the transaction and transmit the notification message to the mobile device 206 using the methods discussed above.

The intermediary service 204 also includes a consumer communication module 420, which is configured to communicate with a consumer 422. The consumer communication module 420 works with a request evaluation module 424 to execute requests received from the consumer 422. In particular, the consumer communication module 420 receives consumer account setup and configuration information and enables the consumer 422 to selectively change their consumer account configuration. As part of its function, the consumer communication module 420 may be configured to receive consumer-specific information relating to service providers, such as the consumer information 402A described previously, including which service providers a consumer utilizes for different consumer services and consumer-specific information related to the various service providers utilized by the consumer. For example, the consumer communication module 420 may be configured to receive a consumer's login or other account information for a particular service provider and/or a consumer's setting or preferences for a particular service provider. To illustrate, the consumer communication module may receive an indication of a user's account with any other type of service provider, such as login information for an identity verification service patronized by a consumer. The consumer communication module 420 may also be configured to manage the distribution of identifiers to consumers. The consumer 422 may also communicate with the consumer communication module 420 to define consumer-specified rules, as discussed above. Consumers 422 may send information to the consumer communication module 420 using a web page or a dedicated application on a personal computer or mobile device. Via a user interface provided by the consumer communication module 420, consumers 422 may also access their historical transaction information that the intermediary service logged.

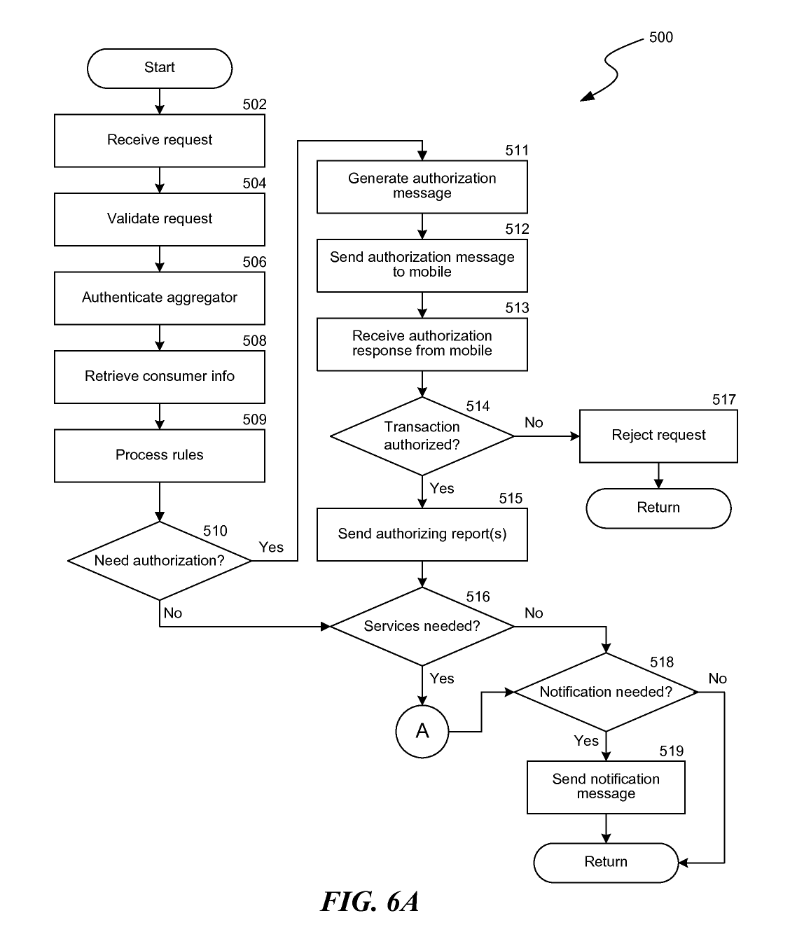

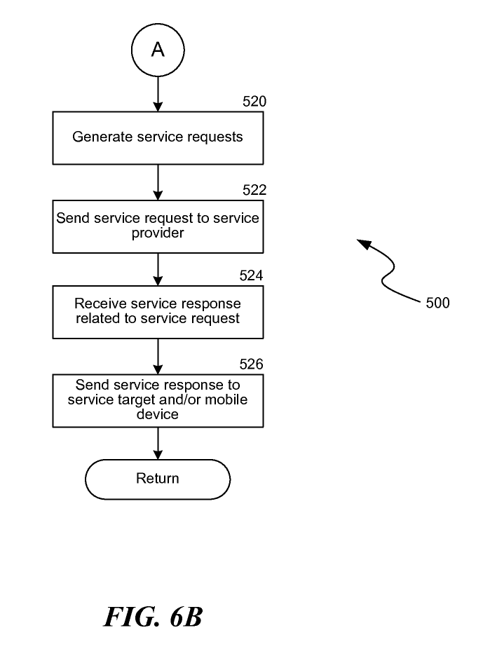

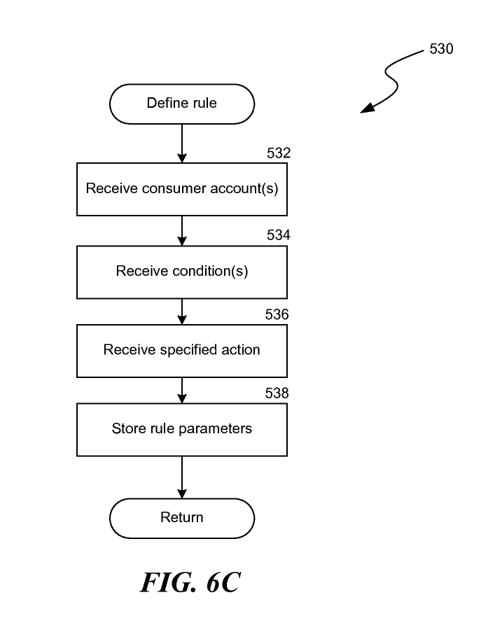

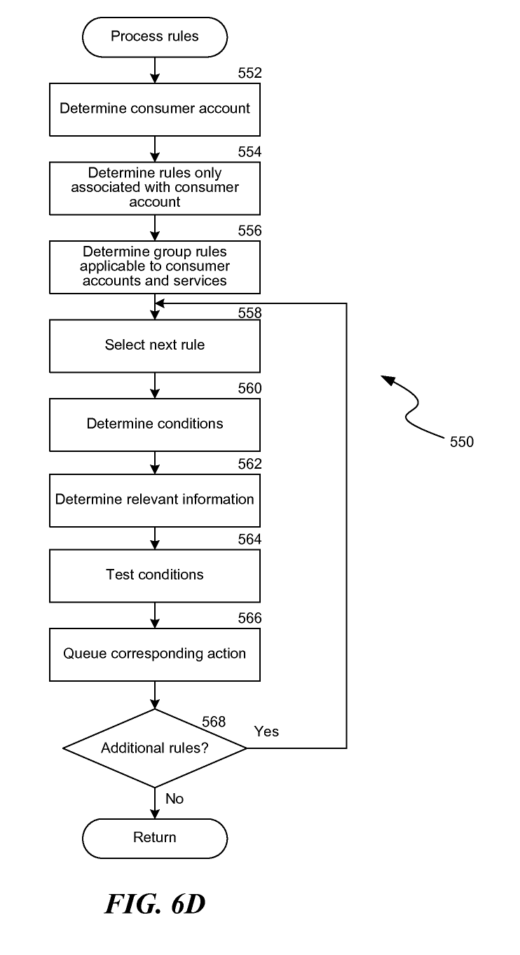

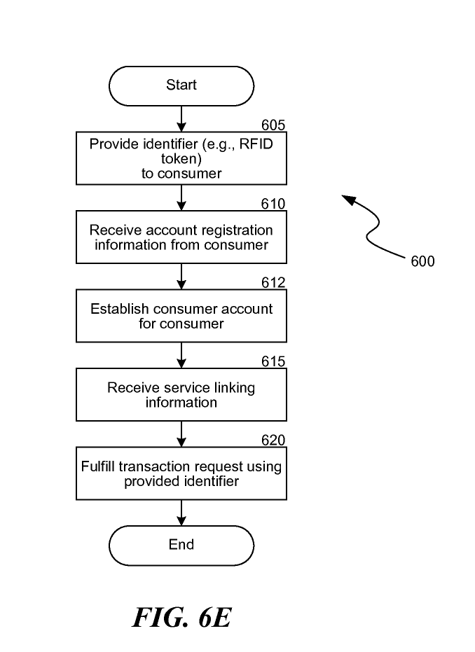

FIGS. 6A and 6B illustrate a flowchart of a process 500 for processing a transaction request executed by the intermediary service 204. Processing begins in block 502, where the intermediary service 204 receives a transaction request from a request aggregator 214. As discussed above, the transaction request includes unique identifying information, transaction information, and point of request information. After receiving a transaction request, processing proceeds to block 504, where the intermediary service validates the request according to the methods discussed above. The validation step may include, for example, verifying that the message is in a proper format and verifying that the message includes the essential data for handling the request. Processing then proceeds to block 506, where the intermediary service authenticates the request aggregator and/or the point of request system 210. As discussed above, the transaction request may include a digital signature provided by the request aggregator 214 that can be cryptographically verified. Alternatively, the intermediary service may authenticate the request aggregator by using a shared cryptographic key to decrypt a portion of the data in the message.

The intermediary service then proceeds to block 508, where it retrieves consumer information corresponding to the information in the transaction request. Retrieving consumer information may be executed by using some or all of the identifying information in the request as an index into a consumer information database. The consumer information may include information for contacting the consumer 102, such as an address of a mobile device 206, telephone numbers, and email or network addresses. The consumer information may also include consumer-specific information relating to service providers and/or one or more verification codes that are each associated with the consumer, the identifier, a requester, and/or other parameters. The consumer information is provided by a consumer during an initial registration process in which the consumer registers with the intermediary service and enters the appropriate information, such as the process shown in FIG. 6E. Alternatively, the consumer information may be provided by, for example, an institution that offers the intermediary service as an added ancillary benefit to other services provided to the consumer.

After retrieving the stored consumer information, processing proceeds to block 509, where the intermediary service processes the rules specified by the rules module 412. The process executed in this step is discussed in greater detail with reference to FIG. 6D. At decision block 510, the rules module determines whether the intermediary service should carry out an authorization procedure that includes an authorization message. If so, processing continues at block 511. Otherwise, the process proceeds directly to decision block 516. At block 511, the intermediary service generates an authorization message. The authorization message includes at least a minimum amount of information to enable the consumer to confirm that they authorize the transaction, or a portion thereof (e.g., a specific consumer service associated with the transaction). Thus, the authorization message may include the requester and/or service provider or related information (e.g., a website, trade name, or product name associated with the requester or service provider), applicable policies, terms, contracts, agreements or similar transaction information that must be acknowledged or accepted by the consumer, and an indication of consumer service details (e.g., the data that would be transferred as a result of a data transfer service). The authorization message may also include additional information related to the transaction, such as textual, graphical, audio or video data that would be useful to the consumer 102 when they review the authorization message; alternatively or additionally, the message may include a link to such information. The authorization message may also specify a service target 212 and/or consumer address to which a service response will be sent. Alternatively, the message may include a list of service targets 212 and/or consumer addresses that may be used and require that the consumer select from the list. In addition, the authorization message specifies a required response from the consumer, such as a confirmation/denial of transaction authorization or the submission of a verification code.

After generating the authorization message, processing continues at block 512, where the intermediary service 204 sends the authorization message to the mobile device 206. Processing then proceeds to block 513, where in reply, the intermediary service receives an authorization response from the mobile device 206.

The intermediary service then proceeds to decision block 514, where it uses the authorization response to determine whether the transaction was authorized (i.e., confirmed) by the consumer. In some cases, the intermediary service may do so by detecting a confirmation indicator in the authorization response, which could simply be a single bit or a “yes” or “no” received from the mobile device 206. Alternatively, if the authorization response includes a verification code, the intermediary service compares the received verification code to a verification code in the stored consumer information 402A. In still other cases, at block 514, the intermediary service may simply wait for a period of time, and if no negative response is received during the period of time, the intermediary service may consider that the consumer has authorized the transaction. In some embodiments, the verification code is encrypted by the mobile device 206 using a one-way hash function. The intermediary service then confirms the transaction by comparing the received hash value to a value generated by applying the same one-way hash function to the stored verification code. Of course, if multiple consumer services are associated with a transaction request and require individual authorizations, steps 511, 512, 513, and 514 may be repeated one or more times for different consumer services.

If the authorization response indicates that the consumer has denied the request or the consumer's verification code does not match the stored verification code even after repeat attempts, processing proceeds to block 517, where the intermediary service rejects the transaction request. At this step, the intermediary service may transmit an authorizing report to the request aggregator; the authorizing report indicates that the consumer has not authorized the transaction (or a portion thereof). In some examples, if the lack of authorization is specific to only a single consumer service (e.g., a consumer denied a data transfer request, but authorized an age verification service), then depending on transaction processing rules, at block 517 the intermediary service may not reject the entire transaction, but only the unauthorized portion thereof. In such examples, the intermediary service may proceed as shown at block 515 with respect to the authorized portions of the transaction that were not denied by the consumer.

If no authorization response is received from the consumer at block 513, such as may occur when there is a communication error or the consumer fails to respond to the authorization message, the intermediary service may re-send (not shown) the authorization message via the same or a different messaging channel. If the consumer fails to respond to the second authorization message, the intermediary service may treat the consumer's failure to respond as a denial of the request and therefore reject the transaction request, and/or take other action based on applicable rules or other algorithms and metrics provided by the consumer, a service provider, the intermediary service, or another party (e.g., an issuer).

If the transaction (or a portion thereof) is authorized by the consumer 102, processing proceeds to block 515, where, in accordance with transaction processing rules, the intermediary service generates and sends an authorizing report to the requester indicating the consumer's authorization of certain consumer services and/or agreement to applicable transaction agreements, terms, etc. The intermediary service may provide the authorizing report at various points in the process 500. For example, the intermediary service may send an authorizing report after generating and sending service requests at blocks 520-522 and/or after receiving service responses at block 524, as described in greater detail herein. In some examples, if the requester is a service target (i.e., the intended recipient of a service response), the authorizing message, in addition to indicating the consumer's authorization of consumer services and/or applicable terms, etc., may also include information from received service responses, as described in greater detail herein.

At block 516 the intermediary service 204 determines if consumer services related to the transaction are needed. To do so, the intermediary service may evaluate the received transaction request and/or applicable rules. In this step, the intermediary service 204 may also determine which consumer services should be requested. The service may do so using information from the transaction request, the consumer information, the service provider information, and/or the consumer's authorization response. In some embodiments, the service may automatically determine consumer services to request based on stored consumer profile information.

If a consumer service is not needed, processing proceeds directly to block 518. Otherwise, processing proceeds to block 520 in FIG. 6B, where the intermediary service 204 generates service requests using information from the transaction request, the consumer information, the service provider information, and/or the consumer's authorization response. The service request may include the desired service target and other details about the service request, such as the identity or location of requested data, etc. After generating the service request in block 520, processing proceeds to block 522, where in accordance with applicable transaction processing rules, the intermediary service sends the service request to an appropriate service provider. In some examples, the intermediary service may itself implement aspects of the requested services, e.g., providing a static coupon code.

Processing then proceeds to block 524, where the intermediary service 204 receives a service response from the service provider. The service response may be encrypted such that it can only be accessed by the service target 212 and/or the mobile device 206 with semantic meta-data for the intermediaries logging and tracking requirements. After receiving the service response, processing proceeds to block 526, where the intermediary service sends the received service responses to the service target 212 and/or the mobile device 206 in a service response message, as described previously. Of course, if multiple consumer services are associated with a transaction request, steps 520, 522, 524, and 526 may be repeated one or more times for different consumer services. Additionally, at block 526, instead of sending multiple service responses to the service target 212 and/or the mobile device 206, the intermediary service may hold and/or aggregate service responses, as described previously. After block 526, processing returns to block 518 of FIG. 6A.

Referring again to FIG. 6A, at block 518, the intermediary service determines if a consumer notification message is needed to notify the consumer of the outcome of the transaction. To do so, the intermediary service may, for example, evaluate applicable transaction processing rules. If a consumer notification message is not needed, the process 500 returns. Otherwise, If a consumer notification message is needed, at block 519 the intermediary service transmits a notification message to the consumer 102 (e.g., to the consumer's mobile device 206) that summarizes the consumer services provided as a result of the transaction. The process then returns.

Although not shown, the intermediary service may log or otherwise record the progression of a transaction request through the various blocks shown in FIGS. 6A and 6B, as described previously. For example, it may log information about the progression of a request in the storage component 204, in conjunction with the consumer's identifying information.

FIG. 6C is a flow chart of a process 530 for defining a rule to be executed by the intermediary service. The intermediary service executes the process 530 for each rule to be defined. The process 530 may be executed by components of the intermediary service 204 (e.g., the rules module 412 and the consumer communication module 420 of FIG. 5) or by a separate management component that is configured to generate rules and store the rules in the storage component 402. Rules information may be specified remotely (e.g., by a consumer, service provider, and/or requester) connecting through a network connection. Processing begins at block 532, where the intermediary service receives an indication of whether the rule applies to an individual consumer account, to a group of consumer accounts, or to all consumer accounts. After the intermediary service receives the applicable account information, processing proceeds to block 534, where the intermediary service receives information specifying one or more conditions for the rule being defined. Since rules may be specific to a particular service provider or class of consumer services, one possible condition is which service providers or consumer services are implicated by a transaction request. The intermediary service then proceeds to block 536, where it receives information specifying one or more actions associated with the rule. The information specifies the actions and also associates the action with a particular result of the conditions. For example, the rule may specify a first action to be performed if the conditions are met (i.e., the conditions return “true” when evaluated) and a second action to be performed if the conditions are not met. Processing then proceeds to block 538, where the intermediary service generates a rule based on the received information and stores the parameters of the rule (e.g., consumer account information, service provider information, conditions, and actions) in the storage component 402. In some embodiments, the intermediary service may also receive and store information specifying an active time interval for the rule.

FIG. 6D is a flow chart of a process 550 for processing rules by the intermediary service 204. The intermediary service executes the process 550 during the processing of block 509 of FIG. 6A, and at other steps where the intermediary service needs to make a determination of suitable actions to take. Thus, the process 550 is executed each time the intermediary service receives a new transaction request and/or at other decision points. Processing begins at block 552, where the intermediary service uses identifying information in the transaction request to determine which consumer account is implicated by the transaction request. Although not shown, at block 552, the intermediary service may also identify the services requested or otherwise implicated by the transaction request. Processing then proceeds to block 554, where the intermediary service determines rules associated with the consumer account. As discussed above, each rule is associated with a consumer service or account or a set of consumer accounts or a combination thereof. In block 554, the intermediary service determines rules that are specifically associated with the consumer account. Processing then proceeds to block 556, where the intermediary service determines rules that apply to any group that includes the consumer accounts and services, including rules that are configured to apply to every account. The intermediary service may also filter the rules to exclude those that are not active at the current time.

Once the intermediary service has determined the full set of applicable rules, processing proceeds to block 558, where the intermediary service selects the first rule from the set of applicable rules. As illustrated in FIG. 6D, the intermediary service processes each rule in a loop until all rules have been processed. One skilled in the art will appreciate the intermediary service may use other methods to process the applicable rules, such as processing the rules in parallel using multiple threads or processes.

After the intermediary service selects the first rule to apply, processing proceeds to block 560, where the intermediary service determines the conditions specified by the selected rule. Since rules may be specific to a particular service provider or class of consumer services, one possible condition is which service providers or consumer services are implicated by the transaction request. Processing then proceeds to block 562, where the intermediary service determines the relevant information for evaluating conditions for the selected rule. The relevant information depends on the particular conditions surrounding the transaction request, and may be derived from the transaction request, from stored data such as the stored consumer, requester, or service provider information, or from data maintained or accessible by the intermediary service, such as the current time. Processing then proceeds to block 564, where the intermediary service tests the conditions based on the relevant information. As previously discussed, the conditions may be connected based on Boolean operators, such as AND or OR operations.

Processing then proceeds to block 566, where the intermediary service determines a corresponding action based on the result of the testing and queues the corresponding action for execution. As discussed above, actions are specified when the rule is defined and correspond to particular results reached by evaluation of the rule. Actions may, for example, direct the intermediary service to authorize the transaction, to reject the transaction, to execute a pre-determined authorization procedure before authorizing a transaction via an authorizing report, to initiate a service request, and/or send a service response. Queuing actions allows the intermediary service to avoid executing redundant or conflicting actions in response to different rules. For example, if evaluation of a first rule indicates that the transaction request should be rejected and evaluation of a second rule indicates that a particular authorization procedure should be executed, only the first action should be executed, because it would be pointless to do the authorization procedure for a rejected transaction. By queuing actions, the intermediary service can look at all actions before attempting to execute any action. After the action is queued, processing proceeds to decision block 568, where the intermediary service determines if there are additional rules to be processed. If there are additional rules, processing returns to block 558, where the intermediary service selects the next rule and repeats the evaluation process. When no rules remain to be evaluated, the process ends. The use of rules allows a consumer, requester, or the intermediary service to specify how transaction requests are processed for particular accounts and/or consumer services.

FIG. 6E is a flowchart of a process 600 for providing intermediary services to a consumer. The process 600 may be performed by the intermediary service 204. The process begins at block 605, when the intermediary service provides an identifier such as an RFID token to a consumer either directly or indirectly (e.g., through another service provider). For example, the identifier may be an RFID identifier configured to attach to a consumer's mobile device via a connector such as a fob, adhesive sticker, static film, etc. An intermediary service may “provide” a biometric identifier by measuring or otherwise obtaining an indication of a biometric associated with a consumer, e.g., obtaining a copy of the consumer's fingerprint. At block 610, the intermediary service receives account registration information from the consumer via the consumer communication module 420. The intermediary service may receive the information directly from the consumer and/or indirectly (e.g., through another service provider that has received the necessary consumer registration information). For example, the intermediary service may receive, e.g., from a consumer's entry into a website or kiosk, the unique identifying information contained in the identifier, an address of a mobile device that is associated with the consumer, telephone numbers associated with the consumer, and email or network addresses associated with the consumer. As another example, the intermediary service may receive consumer-specified rules as described in greater detail herein or other consumer preferences (e.g., a preferred contact method).

At block 612, the intermediary service may establish a consumer account with the intermediary service for the consumer.

At block 615, the intermediary service may receive additional “service linking information” that links or maps various types of service providers to consumer services that the consumer may request in the future; the linking information may be provided by the consumer, a service provider, and/or another party. The linking information may specify which service providers a consumer utilizes for different consumer services. The linking information may also include consumer-specific and/or service-provider-specific information necessary to perform future consumer services for the consumer. As an example, if a consumer wishes to use his identifier to receive insurance verification services in the future, the consumer (or his insurance company) may provide the consumer's health insurance number to the intermediary service. Additionally, the intermediary service may also receive an indication of rules that are specific to certain service providers and/or consumer service types. These received rules may be specific to one or more service providers, to the consumer, or specific to both. The type of service linking information provided will depend on the nature of the consumer service and/or the particular service. Although shown as a discrete step at block 615, one having skill in the art will appreciate that an intermediary service may intermittently receive additional service linking information even after an intermediary service account is opened, for example, if a consumer continues to link new service providers to their intermediary service account.

One having skill in the art will appreciate that blocks 605, 610, 612, and 615 may be performed in any order. During these blocks, the intermediary service may store the received account registration information and service linking information in the storage component 402 in association with the unique identifying information from the consumer's identifier. Although not shown, the intermediary service may take additional steps to verify the consumer's identity and/or the accuracy of the received account registration and service linking information prior to creating the consumer account. For example, the intermediary service may send an activation message to an address of a mobile device and may require that the consumer reply to the activation message in order to establish a consumer account. At block 620, the intermediary service fulfills a transaction request using the identifier that was previously provided to the consumer, e.g., using the process 500 of FIGS. 6A-6B.

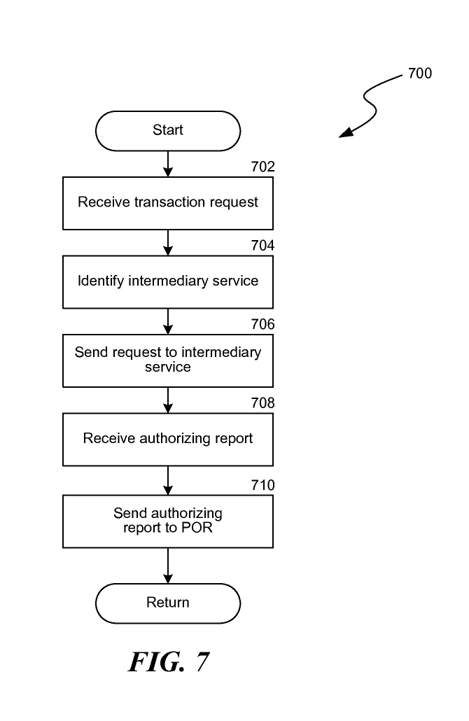

FIG. 7 is a flowchart of a process 700 for processing a transaction request that may be executed by a request aggregator 214. The process 700 is executed by the request aggregator 214 in conjunction with the process 500 of FIGS. 6A and 6B executed by the intermediary service. Processing begins at block 702, where the request aggregator 214 receives a transaction request from the point of request system 210. At a block 704, the request aggregator identifies the intermediary service to which the transaction request should be routed based on the identifying information contained in the transaction request. The determination may include, for example, assessing whether an identifying number contained in the transaction request falls within a range of identifying numbers or has a particular prefix associated with a particular intermediary service 204. At block 706, the request aggregator 214 sends at least part of the data from the original transaction request to the intermediary service 204 in another transaction request.

Processing then proceeds to block 708 where the request aggregator 214 receives an authorizing report from the intermediary service 204 that indicates whether the consumer has confirmed or denied authorization of the transaction. The request aggregator 214 then completes the process by sending the authorizing report to the point of request system 210 in block 710. In some examples, the request aggregator may take other actions before sending the authorizing request to the point of request system.

While the process 700 has been described as being implemented by the request aggregator 214, it will be appreciated that the request aggregator 214 may be omitted, and instead the process 700 can be implemented by any party or component that participates in the transaction approval process, such as the point of request system 210.

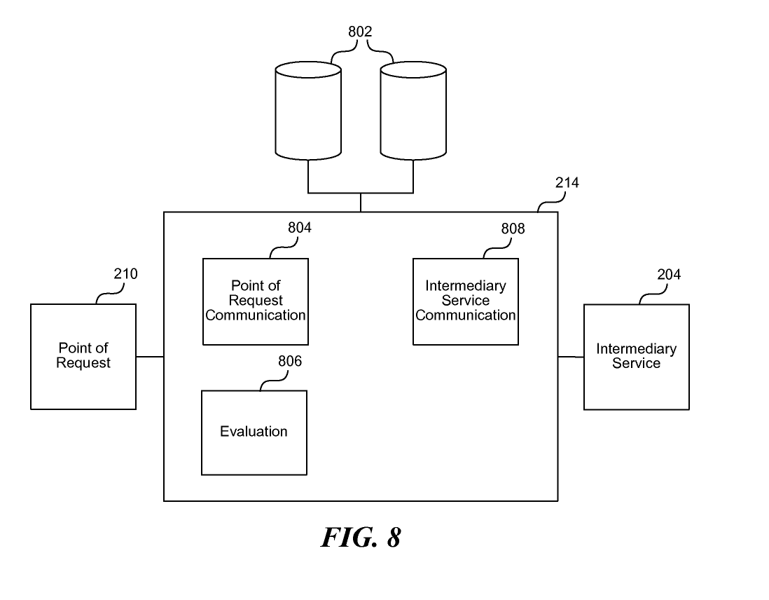

FIG. 8 illustrates a logical block diagram of the request aggregator 214 that implements the process 700 of FIG. 7. The request aggregator 214 processes transaction requests and may perform other functionalities, as described herein. As with the intermediary service 204 shown in FIG. 5, aspects of the request aggregator 214 may be implemented as special-purpose circuitry, programmable circuitry, or as a combination of these. The modules in the request aggregator 214 may be implemented in a single physical device or distributed over multiple physical devices and the functionality implemented by calls to remote services.

The request aggregator 214 includes various modules to assist in processing transaction requests. In particular, the request aggregator 214 includes a point of request communication module 804, which is configured to communicate with the point of request system 210 to receive transaction requests and transmit authorizing reports. The request aggregator 214 also includes an evaluation module 806, which is configured to evaluate transaction requests according to the process 700 described above to determine to which intermediary service 204 to send a transaction request. To do so, the request aggregator may reference information related to intermediary services from a storage component 802. The request aggregator 214 also includes an intermediary service communication module 808, which is configured to communicate with the intermediary service 204 in order to send transaction requests and receive authorizing reports. The request aggregator 214 then forwards the authorizing report to the point of request system 210.

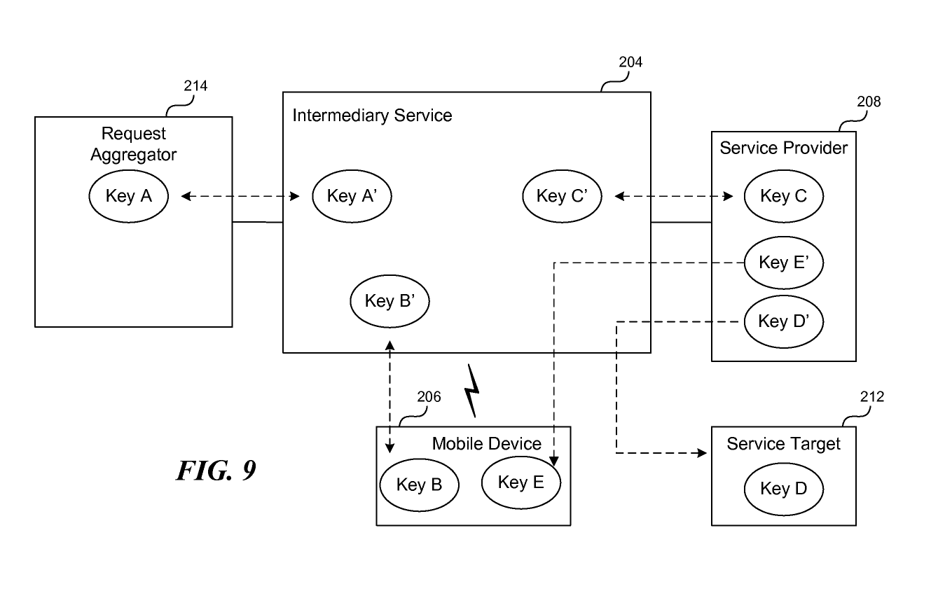

One of the advantages of the disclosed intermediary service 204 is that it allows routing of encrypted messages, such as service responses, through the intermediary service without revealing sensitive information that is contained in the messages to the operator of the intermediary service. FIG. 9 is a block diagram depicting various message routing paths through the intermediary service 204. Complementary encryption keys are depicted as being maintained by different parties that participate in the processing of a transaction request. For example, a key A that is maintained by request aggregator 214 allows the request aggregator to encrypt messages and communicate in a secure fashion with the intermediary service 204, which maintains a complementary key A′ for decoding the encrypted messages. Similarly the intermediary service 204 maintains a key B′ that allows it to communicate in a secure fashion with the mobile device 206, which maintains a complementary key B. Moreover, the intermediary service 204 also maintains a key C′ that allows it to communicate in a secure fashion with the service provider 208, which maintains a key C. Although not shown, the intermediary service 204 may also maintain a key that allows it to communicate in a secure fashion with a point of request system 210, which maintains a complementary key. Of note, however, is the ability of the service provider 208 to exchange encrypted messages or portions of messages through the intermediary service 204 with the service target 212 and/or mobile device 206 without allowing the intermediary service to read or otherwise act on the contents of the messages. For example, the service provider 208 may encrypt requested data related to a transaction using key D′ so that the requested data may be read only by the service target 212 which maintains a complementary key D. Similarly, the service provider 208 may encrypt requested data using key E′ so that the requested data may be read only by the mobile device 206 which maintains a complementary key E. An advantage of this is that the intermediary service 204 never has usable access to the encrypted information. This allows the service target or consumer to retain control over transaction data and increases the privacy of the data. Although the intermediary service may be unable to read encrypted data payload in a service response sent from a service provider, the intermediary service may still receive readable service status information or metadata from a service provider. For example, for a data transfer service, the intermediary service may receive a two-fold service response comprised of (1) an unencrypted message indicating that the service provider was able to retrieve a certain requested data file, and (2) an encrypted version of the certain data file that the intermediary service cannot read. The first message may be utilized to permit the intermediary service to log or track the service response.

From the foregoing, it will be appreciated that specific embodiments of the invention have been described herein for purposes of illustration, but that various modifications may be made without deviating from the invention. For example, those skilled in the art will further appreciate that the depicted flow charts may be altered in a variety of ways. The order of the steps may be rearranged, steps may be performed in parallel, steps may be omitted, or other steps may be included. Accordingly, the invention is not limited except as by the appended claims.

I/We claim:

1. A method for processing data in a server including a processor and an associated storage area, the method comprising:
receiving from a service requester a request generated as a result of a transaction at a point of request,
wherein the request includes a consumer identifier, and
wherein the request specifies a requested service and includes information specific to the requested service;
retrieving consumer information from the storage area based on the consumer identifier, wherein the consumer information includes consumer device information specifying a contact address associated with a consumer device;
determining a service provider corresponding to the requested service;
sending an authorization message to the contact address associated with consumer device,
wherein the authorization message includes information describing the transaction and the corresponding service provider, and
wherein the authorization message specifies a required response from the consumer;
receiving an authorization response from the consumer device in response to the authorization message, wherein the authorization response includes the required response;
transmitting a service request to the service provider, wherein the service request includes at least a portion of the consumer information and the information specific to the requested service;
receiving a service response from the service provider, the service response including information responsive to the service request; and
sending at least a portion of the service response to at least one response target, wherein the at least one response target includes at least one of the consumer device or a service provider target different from the service requester.

2. The method of claim 1, wherein the point of request is a smart poster, an advertising kiosk, a sales or service kiosk, or a register.

3. The method of claim 1, wherein the requested service is a ticketing service, a loyalty program service, an advertising service, a document or data control service, a data transfer service, or an identity verification service.

4. The method of claim 1, wherein the request specifies multiple requested services, wherein the authorization message includes information describing each of the requested services, and wherein the authorization message specifies a required response for each of the requested services.

5. The method of claim 1, further comprising determining the required response based on at least one of the service requester, the requested service, or an intended recipient of the service response.

6. The method of claim 1, wherein a first portion of the request is encrypted using a first encryption method and a second portion of the request is encrypted using a second encryption method, wherein the first portion can be decrypted by the server and the second portion can be decrypted by the service provider and not by the server.

7. The method of claim 1, wherein the required response requires a verification code, and wherein the authorization response further includes a verification code provided by a user of the consumer device.

8. The method of claim 1, wherein the required response is a transaction approval or rejection, and wherein the customer confirmation message includes information indicating an approval or rejection by a user of the consumer device.

9. A system for processing data in a server including a processor and an associated storage area, the system comprising:
a processor;
a storage component;
a requester communication component configured to receive from a service requester a request generated as a result of a transaction at a point of request,
wherein the request includes a consumer identifier, and
wherein the request specifies a requested service and includes information specific to the requested service;
a consumer management component configured to retrieve consumer information from the storage area based on the consumer identifier, wherein the consumer information includes consumer device information specifying a contact address associated with a consumer device;
a mobile device communication component configured to:
send an authorization message to the contact address associated with consumer device, wherein the authorization message includes information describing the transaction and a service provider corresponding to the requested service, and wherein the authorization message specifies a required response from the consumer; and
receive an authorization response from the consumer device in response to the authorization message, wherein the authorization response includes the required response;
a service provider communication component configured to:
transmit a service request to the service provider, wherein the service request includes at least a portion of the consumer information and the information specific to the requested service; and
receiving a service response from the service provider, the service response including information responsive to the service request; and
a service target communication component configured to send at least a portion of the service response to at least one response target, wherein the at least one response target includes at least one of the consumer device or a service provider target different from the service requester.

10. The system of claim 9, wherein the point of request is a smart poster, an advertising kiosk, a sales or service kiosk, or a register.

11. The system of claim 9, wherein the requested service is a ticketing service, a loyalty program service, an advertising service, a document or data control service, a data transfer service, or an identity verification service.

12. The system of claim 9, wherein the request specifies multiple requested services, wherein the authorization message includes information describing each of the requested services, and wherein the authorization message specifies a required response for each of the requested services.

13. The system of claim 9, further comprising a rules engine configured to determine the required response based on at least one of the service requester, the requested service, or an intended recipient of the service response.

14. The system of claim 9, wherein a first portion of the request is encrypted using a first encryption method and a second portion of the request is encrypted using a second encryption method, wherein the first portion can be decrypted by the system and the second portion can be decrypted by the service provider and not by the system.

15. The system of claim 9, wherein the required response requires a verification code, and wherein the authorization response further includes a verification code provided by a user of the consumer device.

16. The system of claim 9, wherein the required response is a transaction approval or rejection, and wherein the customer confirmation message includes information indicating an approval or rejection by a user of the consumer device.

17. A computer-readable medium storing instructions for processing data in a server including a processor and an associated storage area, by a method comprising:
receiving from a service requester a request generated as a result of a transaction at a point of request,
wherein the request includes a consumer identifier, and
wherein the request specifies a requested service and includes information specific to the requested service;
determining consumer information based on the consumer identifier, wherein the consumer information includes consumer device information specifying a contact address associated with a consumer device;
sending an authorization message to the contact address associated with consumer device,
wherein the authorization message includes information describing the transaction and the corresponding service provider, and
wherein the authorization message specifies a required response from the consumer;
receiving an authorization response from the consumer device in response to the authorization message, wherein the authorization response includes the required response;
transmitting a service request to the service provider, wherein the service request includes at least a portion of the consumer information and the information specific to the requested service;
receiving a service response from the service provider, the service response including information responsive to the service request; and
sending at least a portion of the service response to at least one response target, wherein the at least one response target includes at least one of the consumer device or a service provider target different from the service requester.

18. The computer-readable medium of claim 17, wherein the point of request is a smart poster, an advertising kiosk, a sales or service kiosk, or a register.

19. The computer-readable medium of claim 17, wherein the requested service is a ticketing service, a loyalty program service, an advertising service, a document or data control service, a data transfer service, or an identity verification service.

20. The computer-readable medium of claim 17, wherein the request specifies multiple requested services, wherein the authorization message includes information describing each of the requested services, and wherein the authorization message specifies a required response for each of the requested services.

21. The computer-readable medium of claim 17, the method further comprising determining the required response based on at least one of the service requester, the requested service, or an intended recipient of the service response.

22. The computer-readable medium of claim 17, wherein a first portion of the request is encrypted using a first encryption method and a second portion of the request is encrypted using a second encryption method, wherein the first portion can be decrypted by the server and the second portion can be decrypted by the service provider and not by the server.

23. The computer-readable medium of claim 17, wherein the required response requires a verification code, and wherein the authorization response further includes a verification code provided by a user of the consumer device.

24. The computer-readable medium of claim 17, wherein the required response is a transaction approval or rejection, and wherein the customer confirmation message includes information indicating an approval or rejection by a user of the consumer device.
